(19) United States
(12) Patent Application Publication
(10) Pub. No.: US 2020/0097662 A1
(43) Pub. Date: Mar. 26, 2020

(54) COMBINED THREAT SCORE FOR CONTAINER IMAGES

(71) Applicant: CA, Inc., Islandia, NY (US)

(72) Inventors: Brian Hufsmith, Islandia, NY (US); William Mcallister, Islandia, NY (US); Mitchell Engel, Islandia, NY (US)

(21) Appl. No.: 16/146,717

(22) Filed: Sep. 28, 2018

Related U.S. Application Data
(60) Provisional application No. 62/736,162, filed on Sep. 25, 2018.

(51) Int. Cl. G06F 21/57; H04L 9/06

(52) U.S. Cl. CPC G06F 21/577; G06F 2221/033; H04L 9/0643

(57) ABSTRACT

Provided is a process for determining threat scores for container images or distributed applications that consider the results of a multitude of different scanners and other factors such as context information which may include information about a given execution environment for the container image. Scanner results, or scanner properties, are determined for a container image or container images in a multi-container distributed application by various vulnerability scanners. The scanner properties determined by each vulnerability scanner are adjusted responsive to properties of the context and normalized to determine component threat scores for the container image. Then the component threat scores for the container image are combined to generate a combined threat score for the container image within the context of the execution environment.

### CROSS-REFERENCE TO RELATED APPLICATIONS

The present application claims the benefit of U.S. Provisional Patent Application No. 62/736,162, filed on 25 Sep. 2018, which is incorporated by reference herein in its entirety.

### BACKGROUND

### 1. Field

The present disclosure relates generally to tooling for software development related to distributed applications and, more specifically, to techniques that combine metrics of heterogeneous vulnerability scans of container images.

### 2. Description of the Related Art

Distributed applications are computer applications implemented across multiple network hosts. The group of computers, virtual machines, or containers often each execute at least part of the application's code and cooperate to provide the functionality of the application. Examples include client-server architectures, in which a client computer cooperates with a server to provide functionality to a user. Another example is an application having components replicated on multiple computers behind a load balancer to provide functionality at larger scales than a single computer. Some examples have different components on different computers that execute different aspects of the application, such as a database management system, a storage area network, a web server, an application program interface server, and a content management engine.

The different components of such applications, such as those that expose functionality via a network address, can be characterized as services, which may be composed of a variety of other services, which may themselves be composed of other services. Examples of a service include an application component (e.g., one or more executing bodies of code) that communicates via a network (or loopback network address) with another application component, often by monitoring network socket of a port at a network address of the computer upon which the service executes.

In many cases, the bodies of code and other resources by which the services are implemented can be challenging to secure. Often, the range of services is relatively diverse and arises from diverse sets of bodies of code and other resources, thereby increasing the number of potential vulnerabilities. Further, such bodies of code and other resources can undergo relatively frequent version changes, and in many cases the bodies of code and other resources, are downloaded from third parties that create the bodies of code and other resources, such as public repositories that may be un-trusted or accorded less trust than code built in-house. Consequently, detecting and managing potential vulnerabilities in distributed application code and other resources can be particularly complex.

Moreover, even in instances where potential vulnerabilities are detected, a degree to which they pose a threat in a given, and potentially highly complex, execution environment of distributed application code and other resources is difficult to quantify or express in a usable manner. As a result, resources are often used without despite vulnerabilities (even if an administrator or developer is capable of performing a thorough analysis) due to the computational and cognitive load associated with appropriately processing surfaced vulnerabilities.

### SUMMARY

The following is a non-exhaustive listing of some aspects of the present techniques. These and other aspects are described in the following disclosure.

Some aspects include a process including: obtaining, with one or more processors, a plurality of scanner properties pertaining to a container, the scanner properties at least comprising one or more Common Vulnerabilities and Exposures (CVE) scanner properties determined for the container by a first scanner and one or more Common Weakness Enumeration (CWE) scanner properties determined for the container be a second scanner; determining weights for the plurality of scanner properties, each scanner property having an associated metric and value; obtaining, with one or more processors, context properties pertaining to an execution environment of the container; determining, with one or more processors, to which scanner properties each of the context properties applies within the execution environment and weights for the context properties; modifying, by one or more of the weights determined for one or more respective context properties, the weights for the scanner properties to which the respective context properties apply to determine modified weights for at least some of the scanner properties; determining a combined threat score for the container based on the at least some of the scanner properties having the modified weights and the other scanner properties, and storing, with one or more processors, the combined threat score in memory.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1A is a block logical and physical architecture diagram of a computing environment having a scanning engine in accordance with some embodiments of the present techniques;

FIG. 1B is a block logical and physical architecture diagram of a computing environment having a results engine in accordance with some embodiments of the present techniques;

FIG. 2 is a flowchart of an example of a process executed by the scanning engine of FIG. 1A to generate and apply test specifications in accordance with some embodiments of the present techniques;

FIG. 3A is a flowchart of an example of a process executed by a plugin of a integrated development environment to annotate code specifying container images with alerts relating to potential security vulnerabilities in accordance with some embodiments of the present techniques;

FIG. 3B is an example of a user interface created by the process of FIG. 3A in accordance with some embodiments of the present techniques;

FIG. 3C is another example of a user interface created by the process of FIG. 3A in accordance with some embodiments of the present techniques;

FIG. 4 is a flowchart of an example of a process executed by the scanning engine of FIG. 1A to generate container score records in accordance with some embodiments of the present techniques;

FIG. 5 is a flowchart of an example of a process executed by the results engine of FIG. 1A or 1B to generate a combined threat score in accordance with some embodiments of the present techniques;

FIG. 6 is an example of a user interface showing a combined threat score in accordance with some embodiments of the present techniques; and

FIG. 7 is a block diagram of an example of a computing device with which the above-describe techniques may be implemented.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the field of software development tooling. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

Several techniques are described below under different headings in all-caps. These techniques may be used together or independently, which is not to suggest that other descriptions are limiting.

Selectively Applying Heterogeneous Vulnerability Scans to Layers of Container Images

The above-described challenges with managing vulnerabilities in distributed applications are amplified when those applications are built with a particular type of architecture that has seen increased use in recent years. Many developers have migrated from instantiating services as discrete virtual machines to instantiating services as containers, for instance, Docker™ containers, Open Container Initiative (OCI) containers, or with Kubernetes™ (which is not to suggest that items in this list or any other herein describe mutually exclusive categories of items). Containers generally virtualize at the operating system level, in contrast to virtual machines that emulate the underlying hardware as well. OS-level virtualization affords a number of benefits, including lower computational load, faster spin up, and sharing of resources across multiple containers within a given computing device, in some cases with multiple containers implemented on a single kernel. This should not be read to suggest that containers and virtual machines are incompatible, as some implementations may include one or more containers executed within a virtual machine, which may be one of several virtual machines on a given computing device.

Another advantage of some container implementations is that container images are often constructed from multiple layers, also called intermediate images of read-only bodies of code and other resources (other than a top layer) that can be reused across multiple container images. Mutable aspects of the container image, in some embodiments, are isolated to a top, read-write layer, and the overall container image may be described as a collection of accumulated differences between layers, in some cases, as specified by a Dockerfile document. As a result, container images are often relatively extensible, lightweight, and fast to deploy relative to other types of tooling for distributed applications serving a similar role.

Some of the features that provide these performance benefits, however, can make securing the distributed application more difficult. Various ones of the scanning engines available today provide different views into the vulnerabilities associated with a binary or a package in the operating system. The various scanning engines generally provide disparate and often conflicting information about the exposure surface with respect to the files and packages. This can get confusing and results in many false positives when occurring in the context of containers, and it can make it difficult to provide a holistic view into the exposure for a container, due to the layered nature of the container. Typical scanning techniques in this space do not provide multi-sourced vulnerability assessments, which could leave exposures undetected and unchecked. Further, a multi-source approach which includes both Common Vulnerabilities and Exposures (CVE) and Common Weakness Enumeration (CWE) information is lacking. The terms “common” and “weakness” in these acronyms are not terms of degree and are, rather, part of the names of respective ontologies of documented vulnerabilities.

Moreover, the various scanning engines available today do not quantify a degree to which the disparate potential vulnerabilities they detect pose a threat in a given, and often highly complex, execution environment of distributed applications. Thus, in addition to the lack of a multi-sourced vulnerability assessment, there exists no multi-sourced vulnerability assessment that scores potential vulnerabilities within a context of a given execution environment. As a result, a combined threat score for container images is lacking.

None of this is to suggest that all embodiments must address all of these needs, as independently useful techniques are described, and some techniques may address only a subset of these or other issues. Further, the preceding should not be taken to suggest that systems that suffer from these issues are disclaimed, and this qualification should not be read to suggest that any other subject matter described elsewhere herein is disclaimed.

Some embodiments examine each (e.g., each of at least some of all, or each and every) of the layers in a container image and determine consistency with respect to files and packages (and other resources) in each layer. Then based on the file/package information, some embodiments submit those files/packages and other resources to various vulnerability scanning engines (including Veracode™ and others enumerated below) for vulnerability assessment. Based on results, some embodiments provide a relatively comprehensive report of the exposure associated with that container image.

Some embodiments examine the scanner results, or scanner properties, determined for the container image by each of the various vulnerability scanning engines in view of a context of a given execution environment for the container image. The scanner properties determined by each vulnerability scanning engine are adjusted responsive to properties of the context and normalized to determine component threat scores for the container image. Then the component threat scores for the container image are combined to generate a combined threat score for the container image within the context of the execution environment. In this way, the combined threat score represents an overall measure of the exposure associated with that container image within the context of the execution environment.

By analyzing the data in each of the layers of a container, some embodiments extract the binaries and send them to the most appropriate scanning technique across multiple scanning engines. The binary and package information may be assessed and sent to engines to acquire the CVE and CWE information for the binary. Once this is complete, some embodiments may apply algorithms to the results to generate a comprehensive view into the image to obtain a threat assessment, remediation recommendations and exposure report. Some embodiments engage multiple engines to obtain a vulnerability report and use the results of that report to provide a much more accurate threat level for any given package/binary in a container image relative to traditional approaches.

Some embodiments determine a combined threat score for the container image as a whole, which in some cases takes into account the threat levels determined for the packages, binaries, and other resources within the container image and additional information to better represent an overall evaluation of risk associated with utilizing the container. In some embodiments, this additional information, or context, includes properties relating to an execution environment of the container image or other properties (e.g., historical information) relating to the container image that are not accounted for in traditional scanning techniques. Thus, for example, the threat levels for the packages, binaries, and other resources may be adjusted based on the context properties to determine a combined threat score that accurately represents the exposure associated with using the container image.

By using the multi-source scanning approach, some embodiments may include information from the OS vendors as well as binary assessments from tools such as Veracode™. Further, some embodiments are extensible in virtue of a unified application program interface (API), so other scanning results can be engaged as they become available without undertaking expensive and cumbersome rewrites of substantial portions of the code of some embodiments.

As container images are submitted to be scanned, in some embodiments, a layer evaluator may break down the layers and submit detected binaries (and other resources) over to other portions of the scanning engine to be evaluated. The scanning engine, in some embodiments, examines the information to determine the most appropriate (or at least suitable) scanning engine or engines to be used for the information submitted. The scanning engine may use one or more sources for the scans to run on. Each of at least some (or all) of the scanners may use a shared scanner API, allowing the results—scanner properties—to be reported back in a similar format despite the different scanning techniques. Once the full scan is complete, in some embodiments, the information is packaged up and may be sent over to a result engine to be formatted and reported back. Additionally, the result engine may remove commonalities, provide scoring information and mask out at least some (e.g., all) previously identified false positives. Further, in some embodiments, the result engine may analyze and modify one or more of the scanner properties based on contextual information. The information reported back may include one or more combined threat scores that takes into account the contextual information and the scanner properties.

Algorithms in some embodiments of the scanning engine may to determine the best or suitable scanners among a diverse set of scanners, e.g., so that packages go into package scanners, binaries are sent to binary scanners (such as Veracode™), and so on for various resources types. Additionally, candidate scans may be evaluated for chance (or other measure) of success. For example, binaries that include machine code without debug symbols, which would not succeed with a particular scanner that requires debug symbols, may be detected and, in response, sent to a different scanner. Jar files and scripts that can easily be scanned by multiple scanners may be submitted to any available suitable scanner in some embodiments, e.g., by applying load balancing techniques based on a work queues of the various scanners.

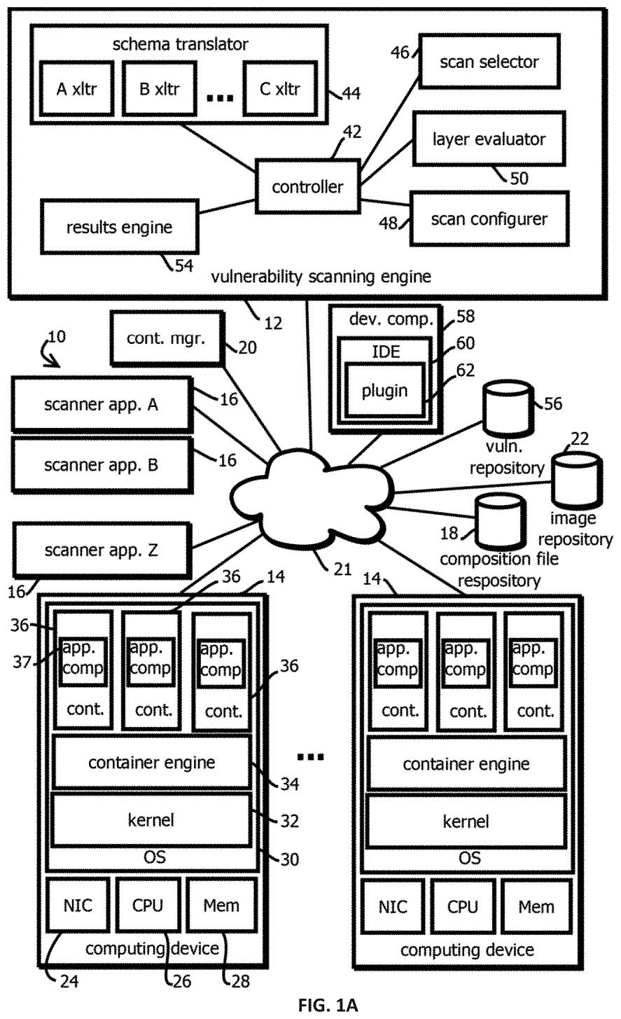

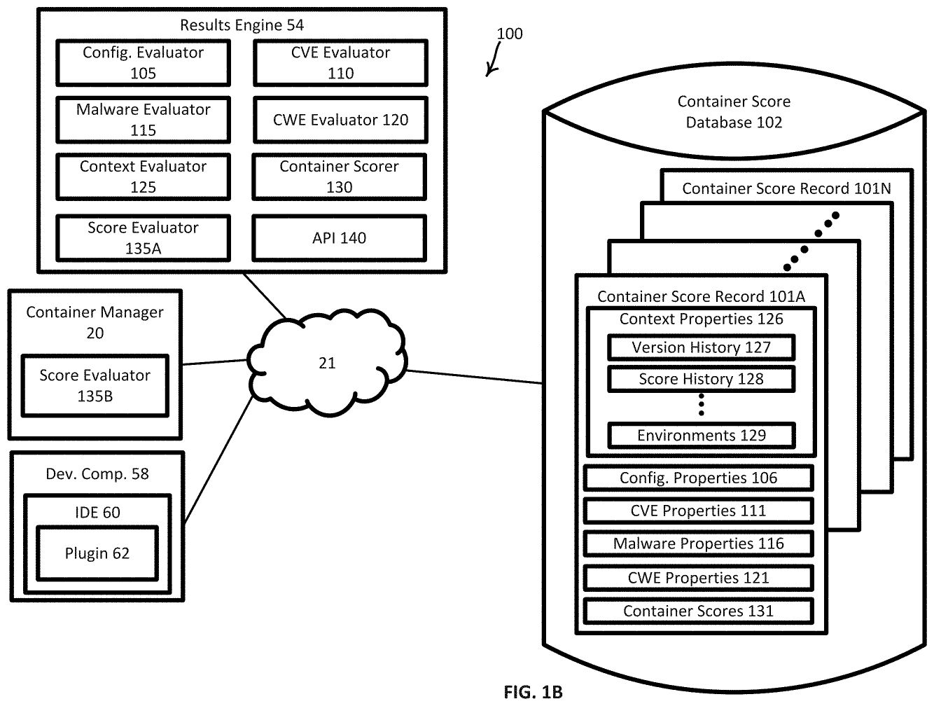

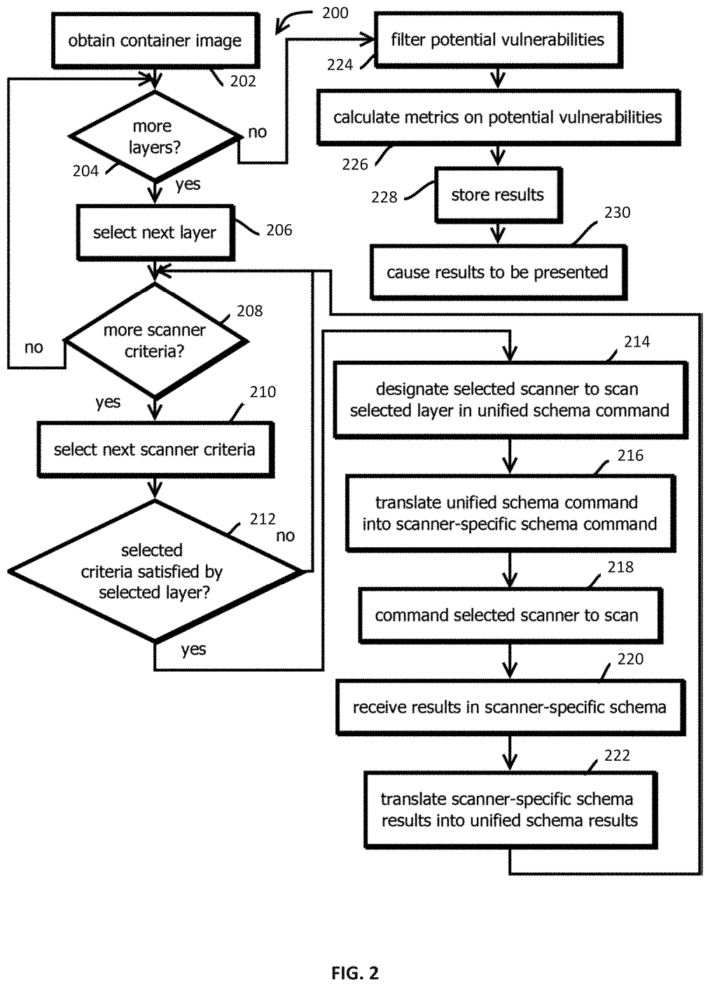

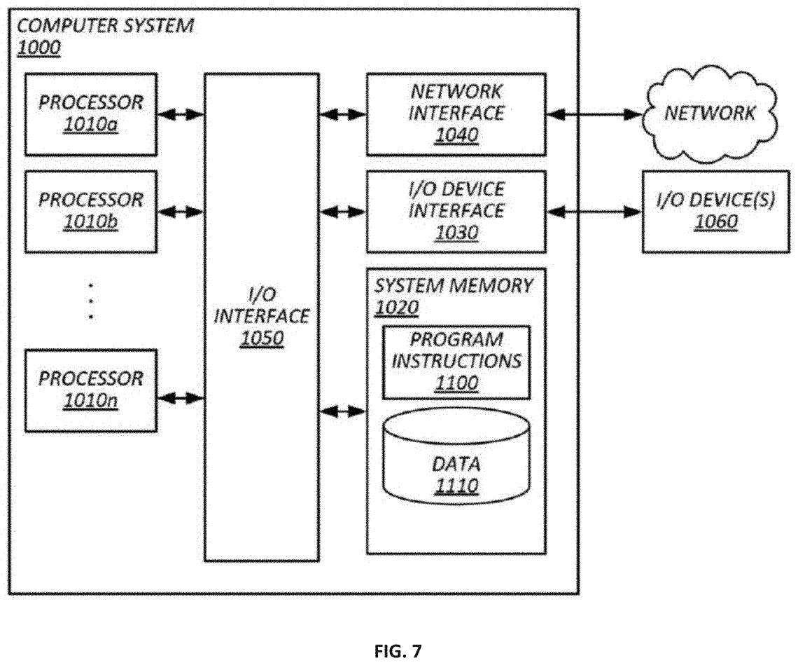

In some embodiments, these techniques may be implemented in a computing environment 10 (e.g., including each of the illustrated components) shown in FIG. 1A by executing processes described below with reference to FIG. 2, 3A, 4 or 5 upon computing devices like those described below with reference to FIG. 7. In some embodiments, the computing environment 10 may include a vulnerability scanning engine 12, a plurality of computing devices 14, scanner applications 16, a composition file repository 18, a container manager 20, and an image repository 22. These components may communicate with one another via a network 21, such as the Internet and various other local area networks.

In some embodiments, the computing environment 10 may execute a plurality of different distributed applications, in some cases intermingling components of these distributed applications on the same computing devices and, in some cases, with some of the distributed applications providing software tools by which other distributed applications are deployed, monitored, and adjusted. It is helpful to generally discuss these applications before addressing specific components thereof within the computing environment 10. In some cases, such applications may be categorized as workload applications and infrastructure applications. The workload applications may service tasks for which the computing environment is designed and provided, e.g., hosting a web-based service, providing an enterprise resource management application, providing a customer-relationship management application, providing a document management application, providing an email service, or providing an industrial controls application, just to name a few examples. In contrast, infrastructure applications may exist to facilitate operation of the workload application. Examples include vulnerability scanning applications, monitoring applications, logging applications, container management applications, and the like.

In some embodiments, the computing devices 14 may execute a (workload or infrastructure) distributed application that is implemented through a collection of services that communicate with one another via the network 21. Examples of such services include a web server that interfaces with a web browser executing on a client computing device via network 21, an application controller that maps requests received via the web server to collections of responsive functional actions, a database management service that reads or writes records responsive to commands from the application controller, and a view generator that dynamically composes webpages for the web server to return to the user computing device. Some examples have different components on different computers that execute different aspects of the application, such as a database management system, a storage area network, a web server, an application program interface server, and a content management engine. Other examples include services that pertain to other application program interfaces, like services that process data reported by industrial equipment or Internet of things appliances. Often, the number of services is expected to be relatively large, particularly in multi-container applications implementing a microservices architecture, where functionality is separated into relatively fine-grained services of a relatively high number, for instance more than 10, more than 20, or more than 100 different microservices. In some cases, there may be multiple instances of some of the services, for instance behind load balancers, to accommodate relatively high computing loads, and in some cases, each of those instances may execute within different containers on the computing devices as described below. These applications can be characterized as a service composed of a variety of other services, which may themselves be composed of other services. Services composed of other services generally form a service hierarchy (e.g., a service tree) that terminates in leaf nodes composed of computing hardware each executing a given low level service. In some cases, a given node of this tree may be present in multiple trees for multiple root services.

As multi-container applications or other distributed applications have grown more complex in recent years, and the scale of computing loads has grown, many distributed applications have been designed (or redesigned) to use more, and more diverse, services. Functionality that might have previously been implemented within a single thread on a single computing device (e.g., as different sub-routines in a given executable) has been broken-up into distinct services that communicate via a network interface, rather than by function calls within a given thread. Services in relatively granular architectures are sometimes referred to as a “microservice.” These microservice architectures afford a number of benefits, including ease of scaling to larger systems by instantiating new components, making it easier for developers to reason about complex systems, and increased reuse of code across applications. It is expected that the industry will move towards increased use of microservices in the future, which is expected to make the above-describe problems even more acute.

Each service is a different program or instance of a program executing on one or more computing devices. Thus, unlike different methods or subroutines within a program, the services in some cases do not communicate with one another through shared program state in a region of memory assigned to the program by an operating system on a single computer and shared by the different methods or subroutines (e.g., by function calls within a single program). Rather, the different services may communicate with one another through network interfaces, for instance, by messaging one another with application program interface (API) commands (having in some cases parameters applicable to the commands) sent to ports and network addresses associated with the respective services (or intervening load balancers), e.g., by a local domain-name service configured to provide service discovery. In some cases, each port and network address pair refers to a different host, such as a different computing device, from that of a calling service. In some cases, the network address is a loopback address referring to the same computing device. Interfacing between services through network addresses, rather than through shared program state, is expected to facilitate scaling of the distributed application through the addition of more computing systems and redundant computing resources behind load balancers. In contrast, often a single computing device is less amenable to such scaling as hardware constraints on even relatively high-end computers can begin to impose limits on scaling relative to what can be achieved through distributed applications.

In some cases, each of the services may include a server (e.g., an executed process) that monitors a network address and port associated with the service (e.g., an instance of a service with a plurality of instances that provide redundant capacity), corresponding to a network host. In some embodiments, the server (e.g., a server process executing on the computing device) may receive messages, parse the messages for commands and parameters, and call appropriate routines to service the command based on the parameters. In some embodiments, some of the servers may select a routine based on the command and call that routine.

The distributed application may be any of a variety of different types of distributed applications, in some cases implemented in one or more data centers. In some cases, the distributed application is a software-as-a-service SaaS application, for instance, accessed via a client-side web browser or via an API. Examples include web-based email, cloud-based office productivity applications, hosted enterprise resource management applications, hosted customer relationship management applications, document management applications, human resources applications, Web services, server-side services for mobile native applications, cloud-based gaming applications, content distribution systems, and the like. In some cases, the illustrated distributed application interfaces with client-side applications, like web browsers via the public Internet, and the distributed application communicates internally via a private network, like a local area network, or via encrypted communication through the public Internet.

Each of the above described distributed applications, services, microservices, and components thereof may be instantiated by way of one or more containers, or container images, which virtualize at the operating-system-level and are executed to perform their respective functions. In many instances, and especially with respect to services and microservices, the functions provided by a given container may be applicable to a variety of different distributed applications. Accordingly, the execution environment of a given container image can vary to the extent of which its functions are applicable, irrespective of an execution environment for which it was originally intended. For example, a given container may expose a function internally, externally, on an in-band network, on an out-of-band network, through an API, through a firewall, etc. or combination thereof depending on its execution environment.

Two computing devices 14 are shown, but embodiments may have only one computing device or include many more, for instance, numbering in the dozens, hundreds, or thousands or more. In some embodiments, the computing devices 14 may be rack-mounted computing devices in a data center, for instance, in a public or private cloud data center. In some embodiments, the computing devices 14 may be geographically remote from one another, for instance, in different data centers, and geographically remote from the other components illustrated, or these components may be collocated (or in some cases, all be deployed within a single computer).

In some embodiments, the network 21 includes the public Internet and a plurality of different local area networks, for instance, each within a different respective data center connecting to a plurality of the computing devices 14. In some cases, the various components may connect to one another through the public Internet via an encrypted channel. In some cases, a data center may include an in-band network through which the data operated upon by the application is exchanged and an out-of-band network through which infrastructure monitoring data is exchanged. Or some embodiments may consolidate these networks.

In some embodiments, each of the computing devices 14 may execute a variety of different routines specified by installed software, which may include workload application software, monitoring software, and an operating system. The monitoring software may monitor, and, in some cases manage, the operation of the application software or the computing devices upon which the application software is executed. Thus, the workload application software does not require the vulnerability scanning application to serve its purpose, but with the complexity of modern application software and infrastructure, often the scanning makes deployments much more manageable, secure, and easy to improve upon.

In many cases, the application software is implemented with different application components executing on the different hosts (e.g., computing devices, virtual machines, or containers). In some cases, the different application components may communicate with one another via network messaging, for instance, via a local area network, the Internet, or a loopback network address on a given computing device. In some embodiments, the application components communicate with one another via respective application program interfaces, such as representational state transfer (REST) interfaces, for instance, in a microservices architecture.

In some embodiments, each application component includes a plurality of routines, for instance, functions, methods, executables, or the like, in some cases configured to call one another. In some cases, the application components are configured to call other application components executing on other hosts, such as on other computing devices, for instance, with application program interface request including a command and parameters of the command. In some cases, some of the application components may be identical to other application components on other hosts, for instance, those provided for load balancing purposes in order to concurrently service transactions. In some cases, some of the application components may be distinct from one another and serve different purposes, for instance, in different stages of a pipeline in which a transaction is processed by the distributed application. An example includes a web server that receives a request, a controller that composes a query to a database based on the request, a database that services the query and provides a query result, and a view generator that composes instructions for a web browser to render a display responsive to the request to the web server. Often, pipelines in commercial implementations are substantially more complex, for instance, including more than 10 or more than 20 stages, often with load-balancing at the various stages including more than 5 or more than 10 instances configured to service transactions at any given stage. Or some embodiments have a hub-and-spoke architecture, rather than a pipeline, or a combination thereof. In some cases, multiple software applications may be distributed across the same collection of computing devices, in some cases sharing some of the same instances of application components, and in some cases having distinct application components that are unshared.

In some embodiments, the computing devices 14 and each include a network interface 24, a central processing unit 26, and memory 28. Examples of these components are described in greater detail below with reference to FIG. 7. Generally, the memory 28 may store a copy of program code that when executed by the CPU 26 gives rise to the software components described below. In some embodiments, the different software components may communicate with one another or with software components on other computing devices via a network interface 24, such as an Ethernet network interface by which messages are sent over a local area network, like in a data center or between data centers. In some cases, the network interface 24 includes a PHY module configured to send and receive signals on a set of wires or optical cables, a MAC module configured to manage shared access to the medium embodied by the wires, a controller executing firmware that coordinates operations of the network interface, and a pair of first-in-first-out buffers that respectively store network packets being sent or received.

In some embodiments, each of the computing devices 14 executes one or more operating systems 30, in some cases with one operating system nested within another, for instance, with one or more virtual machines executing within an underlying base operating system. In some cases, a hypervisor may interface between the virtual machines and the underlying operating system, e.g., by simulating the presence of standardized hardware for software executing within a virtual machine.

In some embodiments, the operating systems 30 include a kernel 32. The kernel may be the first program executed upon booting the operating system. In some embodiments, the kernel may interface between applications executing in the operating system and the underlying hardware, such as the memory 28, the CPU 26, and the network interface 24. In some embodiments, code of the kernel 32 may be stored in a protected area of memory 28 to which other applications executing in the operating system do not have access. In some embodiments, the kernel may provision resources for those other applications and process interrupts indicating user inputs, network inputs, inputs from other software applications, and the like. In some embodiments, the kernel may allocate separate regions of the memory 28 to different user accounts executing within the operating system 30, such as different user spaces, and within those user spaces, the kernel 32 may allocate memory to different applications executed by the corresponding user accounts in the operating system 30.

In some embodiments, the operating system 30, through the kernel 32, may provide operating-system-level virtualization to form multiple isolated user-space instances that appear to an application executing within the respective instances as if the respective instance is an independent computing device. In some embodiments, applications executing within one user-space instance may be prevented from accessing memory allocated to another user-space instance. In some embodiments, filesystems and file system name spaces may be independent between the different user-space instances, such that the same file system path in two different user-space instances may point to different directories or files. In some embodiments, this isolation and the multiple instances may be provided by a container engine 34 that interfaces with the kernel 32 to effect the respective isolated user-space instances.

In some embodiments, each of the user-space instances may be referred to as a container. In the illustrated embodiment three containers 36 are shown, but embodiments are consistent with substantially more, for instance more than 5 or more than 20. In some embodiments, the number of containers may change over time, as additional containers are added or removed. A variety of different types of containers may be used, including containers consistent with the Docker™ standard, Open Container Initiative standard, and containers managed by the Google Kubernetes™ orchestration tooling. Containers may run within a virtual machine or within a non-virtualized operating system, but generally containers are distinct from these computational entities. Often, virtual machines emulate the hardware that the virtualized operating system runs upon and interface between that virtualized hardware and the real underlying hardware. In contrast, containers may operate without emulating the full suite of hardware, or in some cases, any of the hardware in which the container is executed. As a result, containers often use less computational resources than virtual machines, and a single computing device may run more than four times as many containers as virtual machines with a given amount of computing resources.

In some embodiments, multiple containers may share the same Internet Protocol address of the same network interface 24. In some embodiments, messages to or from the different containers may be distinguished by assigning different port numbers to the different messages on the same IP address. Or in some embodiments, the same port number and the same IP address may be shared by multiple containers. For instance, some embodiments may execute a reverse proxy by which network address translation is used to route messages through the same IP address and port number to or from virtual IP addresses of the corresponding appropriate one of several containers.

In some embodiments, various containers 36 may serve different roles. In some embodiments, each container may have one and only one thread, or sometimes a container may have multiple threads. In some embodiments, the containers 36 may execute application components 37 of the distributed application being monitored. In some embodiments, each of the application components 37 corresponds to an instance of one of the above-describe services.

In some embodiments, infrastructure applications in the computing environment 10 may be configured to deploy and manage the various distributed applications executing on the computing devices 14. In some cases, this may be referred to as orchestration of the distributed application, which in this case may be a distributed application implemented as a multi-container application in a microservices architecture or other service-oriented architecture. To this end, in some cases, the container manager 20 (such as an orchestrator) may be configured to deploy and configure containers by which the distributed applications are formed. In some embodiments, the container manager 20 may deploy and configure containers based on a description of the distributed application in a composition file in the composition file repository 18.

The container manager 20, in some embodiments, may be configured to provision containers with in a cluster of containers, for instance, by instructing a container engine on a given computing device to retrieve a specified image (like an ISO image or a system image) from the image repository 22 and execute that image thereby creating a new container. Some embodiments may be configured to schedule the deployment of containers, for instance, according to a policy. Some embodiments may be configured to select the environment in which the provisioned container runs according to various policy stored in memory, for instance, specifying that containers be run within a geographic region, a particular type of computing device, or within distributions thereof (for example, that containers are to be evenly divided between a West Coast and East Coast data center as new containers are added or removed). In other examples, such policies may specify ratios or minimum amounts of computing resources to be dedicated to a container, for instance, a number of containers per CPU, a number of containers per CPU core, a minimum amount of system memory available per container, or the like. Further, some embodiments may be configured to execute scripts that configure applications, for example based on composition files described below.

Some embodiments of the container manager 20 may further be configured to determine when containers have ceased to operate, are operating at greater than a threshold capacity, or are operating at less than a threshold capacity, and take responsive action, for instance by terminating containers that are underused, re-instantiating containers that have crashed, and adding additional instances of containers that are at greater than a threshold capacity. Some embodiments of the container manager 20 may further be configured to deploy new versions of images of containers, for instance, to rollout updates or revisions to application code. Some embodiments may be configured to roll back to a previous version responsive to a failed version or a user command. In some embodiments, the container manager 20 may facilitate discovery of other services within a multi-container application, for instance, indicating to one service executing in one container where and how to communicate with another service executing in other containers, like indicating to a web server service an Internet Protocol address of a database management service used by the web server service to formulate a response to a webpage request. In some cases, these other services may be on the same computing device and accessed via a loopback address or on other computing devices.

In some embodiments, the composition file repository 18 may contain one or more composition files, each corresponding to a different multi-container application. In some embodiments, the composition file repository is one or more directories on a computing device executing the container manager 20. In some embodiments, the composition files are Docker Compose™ files, Kubernetes™ deployment files, Puppet™ Manifests, Chef™ recipes, or Juju™ Charms. In some embodiments, the composition file may be a single document in a human readable hierarchical serialization format, such as JavaScript™ object notation (JSON), extensible markup language (XML), or YAML Ain't Markup Language (YAML). In some embodiments, the composition file may indicate a version number, a list of services of the distributed application, and identify one or more volumes. In some embodiments, each of the services may be associated with one or more network ports and volumes associated with those services. In some embodiments, the composition file may identify various container images included in the distributed application, and in some cases, each of those container images may be specified by a Dockerfile or other body of structured, human-readable hierarchical serialization format document with a collection of commands by which a container image is formed. These documents as well may be stored in the repository 18 or the image repository 22.

In some embodiments, each of the services may be associated with an image in the image repository 22 that includes the application component and dependencies of the application component, such as libraries called by the application component and frameworks that call the application component within the context of a container. In some embodiments, upon the container manager 20 receiving a command to run a composition file, the container manager may identify the corresponding repositories in the image repository 22 and instruct container engines 34 on one or more of the computing devices 14 to instantiate a container, store the image within the instantiated container, and execute the image to instantiate the corresponding service. In some embodiments, a multi-container application may execute on a single computing device 14 or multiple computing devices 14. In some embodiments, containers and instances of services may that be dynamically scaled, adding or removing containers and corresponding services as needed, in some cases, responses to events or metrics gathered by a monitoring application.

In some embodiments, images may be defined (e.g., entirely or partially) according to a container image format. Examples include the Docker™ image format and the Open Container Initiative container image format. In some embodiments, container images are instantiated as container instances in which code of the container image is executed and functionality of the container images provided, for instance, as one of the above-describe services. In some embodiments, container images may be specified by a text file, such as an executable text file encoding a script with a plurality of lines, each line encoding a command by which the container image is at least partially constructed. In some embodiments, each line of this text file may correspond to a layer, also referred to as an intermediate image. In some embodiments, each layer may correspond to a directory formed in the container image upon executing the corresponding line of the text file. In some embodiments, the container image may be defined (for instance entirely or partially) as a stack of these layers, with each layer being expressed as differences relative to an underlying layer down to a base layer, and each of the layers other than a top layer may be read only records.

One advantage of these read-only layers is that they can be reused across container images and containers, as changes in higher layers, for instance in program state, are not propagated down to these lower layers that describe unchanging aspects of a build. This property conserves bandwidth in deployments and orchestration, conserves memory utilization, and makes instantiation and deployment of containers faster relative to techniques that do not reuse portions across container images. That said, embodiments are not limited to systems that afford this benefit, which is not to suggest that any other description herein is limiting.

In some embodiments, each intermediate image, or layer, may have a unique (e.g., in a namespace of the container image) identifier present in a directory name. In that directory, each respective layer may include a file in a hierarchical data serialization format, like JSON, XML, YAML, or the like, that includes the identity of the parent intermediate image (e.g., next lower layer) relative to which differences are determined, for instance, an identifier (like a relative path) of a directory in which that parent intermediate image is disposed in the container image. This file may also include execution in runtime configuration settings, including default arguments, CPU and memory shares, networking parameters, volumes, and an entry point for executable code. In addition to this document, the directory for a given layer may further include a file system change set of the intermediate image, which may include changes applied by that layer (e.g., in virtue of a line expressing a command in a Dockerfile document) relative to the parent layer. In some embodiments, these changes may include an archive (like a tar file) of files that have been added, and archive of files that have changed, and an archive of deleted files relative to the parent layer.

In some embodiments, the container image may implement a union file system, like advanced multi-layered unification filesystem (AUFS), and a collection of these file system change sets, in some cases linked by the parent identifiers in the layers corresponding document. These layers may be merged to form a resulting directory structure of the container image. In some embodiments, this resulting directory structure may be presented, for instance, to the container engine or OS as a union mount of a union file system in which the files of each containers image layers are merged together according to the file system change sets of each of those layers (for example adding, changing, and deleting directories and files therein as indicated by each respective layers file system change set). In some embodiments, the layers may be characterized as a layer graph, in some cases as a tree or other acyclic directed graph, where each node corresponds to an intermediate image, references to parent intermediate images correspond to edges, and the container image is formed by traversing the graph (e.g., with a depth-first or breadth-first recursive traversal) and applying the changes therein. In some embodiments, a base layer may be a directory structure with corresponding files without being expressed as a file system change set.

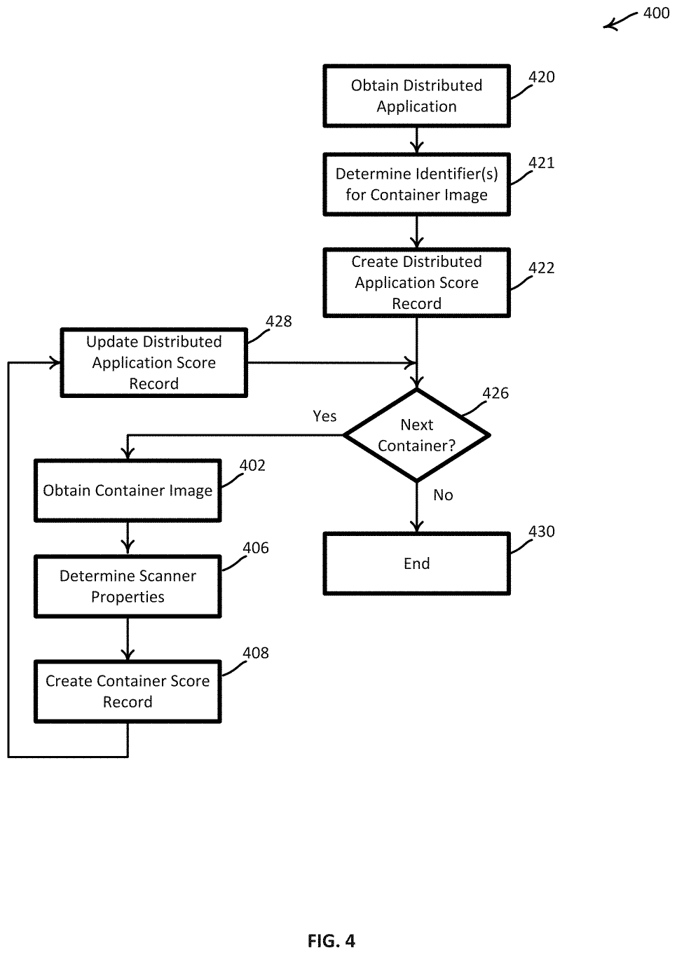

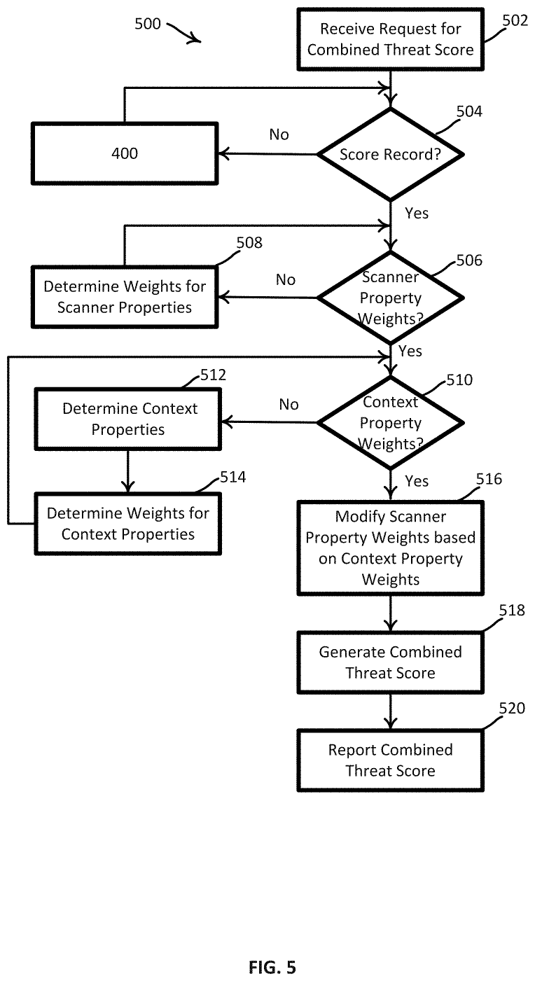

In some embodiments, the vulnerability scanning engine 12 may be configured to detect vulnerabilities of a container image. In some embodiments, the vulnerability scanning engine 12 may be implemented as a SaaS application, for instance, remotely hosted relative to the computing devices 14, or some embodiments may implement part of the vulnerability scanning engine 12 on-premises, in a hybrid cloud architecture, or some embodiments may implement the entire scanning engine 12 on-premises or in a private cloud. In some embodiments, the scanning engine 12 may be implemented as a distributed application consistent with the examples above, or in a single computing device, for instance, on a single host. In some embodiments, the scanning engine 12 (also referred to as the “vulnerability scanning engine”) may expose an API, like a RESTful API, by which the described functionality may be invoked. In some embodiments, the scanning engine 12 may be configured to execute a process described below with reference to FIG. 2 to scan container images for vulnerabilities. In some embodiments, the scanning engine 12 may be configured to execute a process described below with reference to FIG. 4 to scan container images or distributed applications for vulnerabilities and create score records (e.g., score files or attributes of objects in dynamic memory) for the container images or distributed applications. In some embodiments, the scanning engine 12 may be configured to executed a process described below with reference to FIG. 5 to generate a combined threat score for a distributed application or container image, such as with the results engine 54. The scanning image 12 is described with reference to vulnerability scanning, such as security vulnerability scans, but the techniques described may be implemented in accordance with a variety of other types of testing, such as dynamic testing, functional testing, performance testing, and the like, with different types of testing applications invoked for different container images or portions thereof in accordance with the techniques described below.

In some embodiments, the vulnerability scanning engine 12 may include a controller 42 that coordinates the operation of the other components and direct them to describe perform the process of FIG. 2. The scanning engine 12 may further include a schema translator 44, a scan selector 46, a layer of evaluator 50, a scan configurer 48, and a result engine 54. In some embodiments, these components may cooperate to arbitrate which layers and which portions of layers are scanned by which scanner application 16 among a heterogeneous set of scanner applications configured to apply different types of scans to different types of bodies of code and other computing resources (e.g., configuration files, images, audio files, video files, and other non-executed content).

In some embodiments, the controller 42 may be configured to receive a request to scan a container image, for instance, with an identifier of a location of the container image, for instance locally or remotely, or by streaming a copy of the container image. Or in some cases, the request may identify a Dockerfile or other script from which a container image is composable, and embodiments may execute the file to compose a local copy. In response to receiving this request, the controller 42 may obtain the container image, for instance, by accessing a copy in memory or executing commands in a Dockerfile to build the container image. The obtained container image may be provided to the layer of evaluator 50.

The layer of evaluator 50 may traverse the layer graph, for instance, starting with a base layer or a top layer and call the scan selector 46 with each visited or otherwise identified layer to request that a scan be selected for the identified layer. In some embodiments, layers may be scanned in the form of a set of differences relative to an underlying layer, or in some cases layers may be scanned as the accumulation of each of the underlying layers and that layer, for instance, by merging each of the underlying layers up to that point. Or in some cases, layers may be scanned in both forms, as an accumulated image and as an isolated set of differences relative to a parent layer. In some cases, a scan for a given layer of a container image may be accessed in response to detecting that a scan of another container image references the same immutable layer, thereby expediting scans of larger collections of container images that share layers. Some embodiments may add identifiers of scanned layers to an index that maps the identifier to scan results, and some embodiments may interrogate that index at each layer to determine whether to re-use a previous scan (responsive to detecting the layer identifier in the index) or scan the layer.

In some embodiments, the scan selector 46 may receive the identified layer upon each call and select scanner application (or applications) 16 to scan various portions (or all) of the identified layer. In some embodiments, a given layer may be scanned by multiple scanner applications, such as multiple scanner applications of different types or multiple scanner applications of the same type. In some embodiments, different portions of a given layer may be scanned by different scanner applications, in some cases with some portions of a given layer not being scanned at all and other portions of the given layer being scanned by multiple different scanner applications of the same or different type. In some embodiments, some scanner applications may not be applied to any portion of a given layer, and in some cases an entire layer may be scanned or only a subset of the layer. Reference to scanning the layer should be read broadly to include both (partially or entirely) scanning the differences expressed in that layer or (partially or entirely) scanning an image formed by merging that layer with each underlying layer.

In some embodiments, the scan selector 46 compares scanner criteria of each of the illustrated scanners 16 to attributes of a layer to determine which of the scanners are suitable for scanning the given layer, in some cases selecting the scanners that are suitable, or in some cases, ranking scanners and selecting those above a threshold rank, for instance, based upon queue length, the number of criteria that are satisfied, or a weighted score of values indicating which criteria are satisfied (or a combination thereof).

In some embodiments, each scanner application may have different criteria by which the scan selector 46 determines whether that scanner application is suitable for the currently processed layer or portion thereof. In some embodiments, these criteria may be arranged hierarchically, for instance, scanners may be organized by type, like in a taxonomy, and each layer of the taxonomy may have type-specific criteria. Embodiments may traverse the resulting tree of criteria to select scanner applications corresponding to leaf nodes of the tree. Examples include criteria corresponding to scanners suitable for scanning bytecode by which bytecode type scanners are selected and criteria corresponding to scanners suitable for scanning machine code by which a different type of suitable scanners are selected. Other types include scanners for various types of bytecode (e.g., Java™, NET™, Python™, etc.), scanners for various source code of interpreted languages (e.g., Python™, JavaScript™, and the like), and scanners for various configurations of build processes (e.g., whether debug symbols are included).

In some embodiments, the criteria are compared to attributes of different portions of a layer. Those attributes may include a metadata of a directory of the layer, like aspects of file system paths, file names, and file extensions, like a regex that matches to file extensions, or a regex that matches to a bytecode or machine code schema. Other metadata attributes include creation dates, authors, file sizes, and the like. In some embodiments, the criteria are compared to attributes of content of items in those file system objects, like content of files, such as bitstreams, n-grams in text documents, character sequences in documents, and the like.

In some embodiments, the criteria (a term which is used generally herein to reference both the singular criterion and the plural criteria) may include a pattern and indication of consequences of the pattern matching or not matching. For instance, embodiments may indicate that a scanner or type of scanner is to be selected in response to the pattern matching, and embodiments may indicate that a scanner or type of scanner is to not be selected in response to the pattern matching. Or in some cases embodiments may indicate that a scanner or type of scanner is to be selected in response to the pattern not matching, or embodiments may indicate that a scanner or type of scanner is to not be selected in response to the pattern not matching.

In some embodiments, patterns may be expressed as dictionaries, regular expressions, signatures, or models, like trained classification models. In some embodiments, a pattern may include a dictionary of n-grams that if present indicate the pattern is matched. In some embodiments, the pattern may include a regular expression that is matched. In some embodiments, the pattern may include a signature, like a hash digest of a portion of a file or file system, and the pattern may be deemed matched if a hash digests calculated on a corresponding portion of a file or file system of the layer produces the same hash digest value (like a MD5 hash, a SHA256 hash, or the like). In some embodiments, classification models may be trained on labeled layers in a training set, and the pattern may be deemed matched upon a designated classification being indicated after inputting the layer at issue into the trained classification model.

In some embodiments, the scan selector 46 may recursively traverse a directory of the layer at issue (e.g., as a set of differences from a lower layer, or as a union of the current layer and lower layers) and determine for each encountered body of code or other resource (e.g. configuration file, image, or the like) whether the encountered resources suitable for scanning and select one or more scanners for the encountered resource. In some embodiments, scan selector 46 may select scanners for larger arrangements, like selecting a scanner for an entire layer, or selecting a scanner for an entire subdirectory or application and related data within a layer.

By way of example, scan selector 46 may recursively traverse a directory of a given layer until an executable file is detected. Embodiments may then select a scanner based upon a file extension of that executable file, for instance, selecting one type of scanner for .Jar files, another type of scanner for an .exe file, and a different type of scanner for a .pyc file.

In some embodiments, the controller 42 may receive for each layer or a subset thereof selection sets of scanners for respective layers from the scan selector 46. In some cases, selection sets may include a plurality of records that pair layers or portions thereof with corresponding scanners, each record corresponding to an individual scan request. In some embodiments, the controller 42 may send the scan request to scanner applications 16, in some cases via the schema translator 44.

In some embodiments, the scanning engine 12 may abstract away details of communicating with the different scanner applications from other logic of the scanning engine with the schema translator 44. This is expected to make the scanning engine 12 relatively extensible, facilitating the addition of new types of scanners as additional scanners become available. In some embodiments, the schema translator 44 may be configured to translate commands and data between API schemas and data schemas specific to each scanner application 16 (each of which may have a different API schema or data schema, which is not to suggest that an API schema may not also specify a data schema) and a unified API schema and data schema of the scanning engine 12 by which the controller 42 communicates with the schema translator 44, in some cases without regard to with which scanner application the controller 42 is communicating.

In some embodiments, the schema translator 44 may include a plurality of scanner application specific translator modules. In some embodiments, the translator modules may be characterized as scanner drivers or scanner interface modules. In some embodiments, each module may include logic by which a scanner-specific schema is translated to or from a unified schema of the scanning engine 12. In some cases, this may include mappings of field names and hierarchical data serialization formats, like keys in keyvalue pairs between the schemas. In some cases, this may include routines to translate a normalization of data between formats. In some cases, this logic may include logic to change formats of data specified by the different schemas. In some embodiments, this logic may include logic to supply (e.g., default values) required values present in one schema but not the other.

In some embodiments, the translator commands may be sent to the specified scanner application 16, in some cases along with the resources to be scanned or a reference thereto by which the scanner application may obtain the resources to be scanned. Three scanner applications 16 are shown, and each scanner application may be a different scanner application executed as a different process, in some cases on different computing devices, in some cases accessed as a SaaS offering or executed on-premises. The scanner applications may be any of a variety of different types, including but not limited to (which is not to imply that any other listing is limiting herein) the following: a static analysis scanner; a dynamic analysis scanner; a malware analysis scanner; an antivirus scanner; or a configuration scanner.

In some cases, scanner applications may instantiate an intermediate container image and execute code of the intermediate container image, or execute code of an application therein, to dynamically test the body of code for vulnerabilities. Examples of such dynamic tests include calling an API exposed by that body of code with API requests including code injection attacks and including parameters configured to cause a buffer overflow to detect whether the code appropriately handles the attack or if it allows access or privilege escalation when it should not.

In some cases, scanner applications may scan the identified resources from the scan request to identify any of a variety of different types of vulnerabilities, examples include those identified in public repositories, such as repositories of CVE or CWE vulnerabilities. In some cases, each vulnerability may have a unique identifier in a namespace of such repositories, and embodiments may reference that identifier in results.

In some embodiments, after scanning, each scanner application may return a response indicating a result, or other types of scanner properties, of the scan. Results, or scanner properties, may identify a set of potential vulnerabilities exhibited by the resources for which a scanner was requested. In some cases, each scanner may report results according to a different schema, and those results may be received by the controller 42, which may request the schema translator 44 to translate the results from scanner-specific schemas into the unified schema of the scanning engine 12. Results in the unified format may be provided to the result engine 54.

Results, or other types of scanner properties, in the unified format may also be stored by the controller 42 for subsequent processing by the results engine 54. For example, in some embodiments, the scanner properties determined by each scanner called throughout the scan of the container image may be stored in a database or other type of memory. Thus, for example, when the scan of a container image is complete, a database or other type of memory may contain a set of scanner properties determined by scanner application A for the container image, a set of scanner properties determined by scanner application B for the container image, and so on. The sets of scanner properties may be stored in association with an identifier for the container image such that they may be referenced by the results engine 54 or other component. In some embodiments, the controller 42 determines a cryptographic hash of the container image (e.g., by inputting the image bitstream into a hash function such as SHA-256), and the cryptographic hash value serves as the identifier for the container image. In other embodiments, the identifier of the container image may be file name, location, version or combination of thereof that uniquely references the container image. One benefit of using a cryptographic hash value of a container image itself as the identifier for the container image over a file name (e.g., Ubuntu™) is that any modification of the container image will cause the cryptographic hash value determined by the hash function to change. In turn, if a cryptographic hash value determined by the hash function for a container image does not reference any scanner properties in the database or memory, that container image has not been scanned by the vulnerability scanning engine 12. Similarly, with respect to multi-container distributed applications, a cryptographic hash of the composition file for the multi-container application indicates that the composition file has not changed, and in turn, if the hashes of the container referenced therein are unchanged the multi-container application has not been modified either by a change in the composition file or a change in a referenced container image.

In some embodiments, the result engine 54 may be configured to filter potential vulnerabilities corresponding to those in a list of known false positives. In some cases, each vulnerability may include a unique identifier specified in one of the above-described databases, or in some cases vulnerable potential vulnerabilities may be specified by a vulnerability type, a resource name, and a resource version. Embodiments may interrogate a list of known false positives and filter out those that are documented as known false positives (which may include labeling those as being known false positives in a set advance for further processing).

In some embodiments, the result engine 54 may be configured to de-duplicate potential vulnerabilities in a layer or a container image. For example, the same potential vulnerability may be identified in each layer after a given layer, and embodiments may collapse these potential vulnerabilities into a single record. The duplication in this case may include grouping the corresponding potential vulnerabilities that identify the same underlying vulnerability into a group such that an analyst can readily discern that they are potential duplicates, or the de-duplication in this case may further include deleting all but one of the potential vulnerabilities in such a group.

In some embodiments, the result engine 54 may be configured to detect that a potential vulnerability present in one layer is removed by a deletion in a different higher layer and filter out those potential vulnerabilities that are addressed by the subsequent change. For example, a vulnerability may be present in a first version of an application package in a container image and a higher layer may modify that lower layer to correspond to a subsequent version in which the potential vulnerability is removed.

In some embodiments, the result engine 54 is configured to calculate various aggregate metrics for a container image or subset thereof. In some cases, this may include calculating layer-specific risk scores (in some cases, with risk scores specific to portions of a layer) and container-image specific risk scores. Such risk scores may be based, for example, on a count of the number of potential vulnerabilities detected. Some embodiments may calculate a weighted sum of detected potential vulnerabilities, and some cases with different weights corresponding to different vulnerabilities or types of vulnerabilities in a taxonomy of vulnerabilities. In some embodiments, aggregate metrics may include a classification of layers or container images based upon potential vulnerabilities identified.

Some embodiments of the results engine 54 may calculate a combined threat score (e.g., single score, e.g., a one-dimensional, cardinal or ordinal value with three, five, ten, a hundred or more possible values in a scoring range from a maximum to a minimum) for a container image. In some cases, high values may indicate safety and low values indicate risk, or vice versa. The combined threat score may be based on a weighted sum of detected potential vulnerabilities. Different detected potential vulnerabilities may have different weights corresponding to different vulnerabilities or types of vulnerabilities in a taxonomy of vulnerabilities. In some embodiments, to calculate a combined threat score, the results engine 54 adjusts one or more of the weights corresponding to different vulnerabilities or types of vulnerabilities from the taxonomy of vulnerabilities based on context properties representing additional factors that may not be accounted for in traditional scanning techniques.

For example, the results engine 54 may adjust weights associated with one or more vulnerabilities based on contextual properties such as an execution environment of the container image or other properties (e.g., historical information) that may implicate an increase or decrease in risk associated with a given vulnerability. In a specific example, a given vulnerability or a given type of vulnerability may pose an increase in risk over a baseline value if (e.g., if and only if) container functions are exposed externally, pose baseline risk if exposed via an externally accessible API, pose decreased risk if exposed via an internally accessible API, pose minimal to no risk if exposed via an API only accessible on an out-of-band network, etc. Accordingly, the results engine 54 may adjust a weight associated with a detected potential vulnerability or type of detected potential vulnerability based on one or more context properties indicating an intended (or selected or inferred, e.g., based on a Docker compose file or other orchestration configuration) execution environment for the container image.

In some embodiments, a trustworthiness of an author or source of a container image may indicate an increase or decrease in risk associated with a given vulnerability or type of vulnerability, such as malware. If a container image originated from an unknown or untrusted source, a detected potential vulnerability having the type malware may pose a greater risk than if the container image originated from a trusted source. Accordingly, the results engine 54 may obtain such indicia and adjust a weight associated with a detected potential vulnerability or type of detected potential vulnerability based on one or more context properties (e.g., historical information) indicating a trustworthiness of the source of the container image.

Thus, the results engine 54 may retrieve, determine, or otherwise obtain one or more context properties pertaining to a container image and adjust one or more weights associated with different detected vulnerabilities or detected types of vulnerabilities reported by scanner applications for the container image. In turn, the results engine 54 may calculate a combined threat score (e.g., single score) for a container image based on a weighted sum of context adjusted weights associated with the detected potential vulnerabilities. As context properties may differ for a same container image (e.g., due to differing intended execution environments (which includes code that invokes various subsets of the functionality of a container) and other factors), a combined threat score may be context specific or specific to a class of contexts. In other words, a combined threat score may represent exposure risk associated with using a given container image in a given way. Additional context properties and determinations based thereon are explained in greater detail below.

Some embodiments of the results engine 54 may train a classification model on container images or layers thereof in a labeled training set and input the potential vulnerabilities or context properties into the classification model to produce a classification that may be presented as a combined threat score metric of the result engine. In some embodiments, the scanning engine may be requested to scan an entire decentralized application, including each container image by which it is constituted, and embodiments of the results engine 54 may calculate or otherwise determine combined threat score metrics for the entire decentralized application or portion thereof, which may include a plurality of different container images. In some embodiments, a combined threat score may be determined for a distributed (e.g., centralized or decentralized) application based on one or more combined threat scores (e.g., as an average, weighted sum, min or max score, etc.) corresponding to container images which constitute the application.

In some embodiments, the result engine 54 is configured to output the results of one or more calculations or determinations about container images or distributed applications, for instance, storing them in memory, causing the results to be presented to a user, for instance, in a user interface, like a dashboard a report, logging results, for instance, an alarm log, or causing a message to be sent to a developers email address or text message address. In some embodiments, the resulting metrics, in some cases, may be presented with user selectable links through to descriptions of the potential vulnerabilities upon which those metrics are based, and in some cases, the potential vulnerabilities or the metrics may be presented with links through to the layers of the container image or the container image giving rise to those potential vulnerabilities. In some embodiments, results may be output in a dashboard or report for an entire decentralized application with corresponding links through to container-image specific views on the metrics or potential vulnerabilities. In some embodiments, a computing device may be caused to present the results by invoking an application program interface of a local operating system to display the results in a window of a local operating system executing the scanning engine, or results may be caused to be presented by a remote computing device, for instance, by sending instructions to a web browser executing in the remote computing device to render a display of the results and present inputs by which a user may navigate in the manner described above.

In some embodiments, results output by the results engine 54 for a given container image may be stored in memory or a database in association with an identifier corresponding to the container image. The results engine 54, database, or other component may be queried with an identifier corresponding to a container image or a collection of identifiers (e.g., corresponding to container images which constitute a distributed application) to retrieve results associated with one or more container images. In turn, a developer, administrator, or orchestration component (e.g., such as a container manager) may evaluate the results to determine whether to use a particular container image. Further examples are discussed below.

Combined Threat Score for a Distributed Application or Container Image

FIG. 1B illustrates a computing environment 100 for executing processes or parts of process described below with reference to FIGS. 2, 3A, 4 and 5 upon computing devices like those described below with reference to FIG. 7. In some embodiments, the computing environment 100 may be incorporated into the computing environment 10 of FIG. 1A, e.g., by incorporating one or more of the components discussed with reference to FIG. 1B into components of FIG. 1A or by communication via network 21 where the network includes local area networks. In some embodiments, the computing environment 100 may include one or more components that communicate with one or more components of the computing environment of FIG. 1A, e.g., via network 21 where the network includes the Internet or various other local networks. In some embodiments, the computing environment 100 may operate independently of the computing environment 10 of FIG. 1A, e.g., as a third-party service. Thus, it should be understood that each of the components discussed with reference to the example configuration shown in FIG. 1B may be wholly or partially incorporated into environment 10 of FIG. 1A or wholly or partially instantiated independent of the environment 10 of FIG. 1A depending on a desired configuration (e.g., to provide a third party service, an internal service, or both) or integration with other existing computing environments or components (which may differ from that of FIG. 1A), none of which is to suggest that the above-described features may not also be similarly subdivided.

As shown, the computing environment 100 of FIG. 1B may include a results engine 54, container score database 102, container manager 20 and developer computer 58. In some embodiments, the results engine 54, container manager 20, or developer computer 58 shown in FIG. 1B also function as the respective components illustrated in FIG. 1A. These components may communicate with one another via a network 21, such as the Internet and various other local area networks. In addition, these components may communicate with one or more of the components illustrated in FIG. 1A via network 21 over the Internet or one or more local area networks. Thus, for example, the network 21 may include the public Internet, a plurality of different local area networks, and utilize one or more of the communications technologies described herein.

As described above, embodiments of a vulnerability scanning engine (such as engine 12 in FIG. 1A) may translate vulnerability scanner application results having a scanner-specific schema into a unified schema of scanner results or scanner properties. Scanner properties in the unified schema for a container image may be stored in association with an identifier of the container image in a database (e.g., a container score database 102). During a vulnerability scan of a container image by the vulnerability scanning engine, one or more scanner applications may be requested to scan the container image or one or more components (e.g., layers) thereof. As a result, the vulnerability scanning engine may store a plurality of sets of scanner properties in the database. In one embodiment, each set of scanner properties stored in association with an identifier of a container image contains scanner properties in the unified schema for a one or more scanner applications.

An example container score database 102 is shown. The container score database 102 may include a number (e.g., a plurality) of container score records 101A to 101N, the number of which may be greater than 10, 100, 1,000, or 10,000, depending on implementation (e.g., whether utilized in a 1^{st} party or 3^{rd} party environment and may roughly corresponding to a number of different container images scanned). A given container score record, e.g., 101A, may be referenced in the container score database 102 by an identifier, such as by an identifier of a container image for which properties in the container score record 101A correspond. A given container may have multiple images, e.g., corresponding to different versions. In some embodiments the identifier is a cryptographic hash value determined by a cryptographic hash function that receives the container image as an input of the hash function and returns the cryptographic hash value. Thus, for example, the container score record 101 for a given container image may be referenced in the container score database 102 by the cryptographic hash value of the container image, thereby ensuring with sufficient probability that a retrieved container score record pertains to that specific container image and not some other container image having a same file name, version, etc. (e.g., to ensure the obtained container image has been scanned for vulnerabilities and to assist a developer in determining whether utilization of the container poses acceptable risk). Similarly, with respect to multi-container distributed applications, a cryptographic hash of a composition file for a multi-container application may be used to reference (e.g., uniquely within a namespace of the illustrated system) a score record pertaining to the distributed application. The score record for the distributed application may reference container images which constitute the multi-container application by their hash values such that the container score records for the container images may be referenced within the container score database 102.

Container score records 101 may also be referenced in the container score database 102 by other or additional identifiers. In such instances, container score records 101 may be referenced based on criteria other than a cryptographic hash value. For example, some embodiments of the container score database 102 are operable to reference one or more container score records 101 by criteria such as a name or version, container image type or function, etc., to facilitate the retrieval of container score records relative to one or more container images meeting the specified criteria (e.g., to assist a developer in determining which one of a plurality of container images to utilize based on a risk associated with each container image).

A given container score record 101 may be specific to a particular container image or to a number of container images (e.g., those within a particular distributed application). In the case of a container score record 101 pertaining to a distributed application, the container score record may reference one or more other container score records corresponding to the container images which constitute the distributed application (e.g., by cryptographic hash). In either instance, a container score record 101 may contain scanner properties determined by scanner applications or other applications that analyze container images and subsequently store determined results or properties of the scan in the database 102 (e.g., as done by example vulnerability scanning engine described with reference to FIG. 1A). For example, the illustrated container record 101A may include configuration properties 106, CVE properties 111, malware properties 116, and CWE properties 121. Each set of which may be determined, for example, by one or more scanner applications (e.g., scanner applications A-Z described with reference to FIG. 1A) and reported to the database 102 as scanner properties in a unified format. For example, the CVE properties 111 may contain a set of CVE vulnerabilities in the unified format as determined by a vulnerability scanning engine 12 through one or more scans of a container image by one or more scanner applications.

As an example, configuration properties 106 may correspond to a set of configuration properties determined by a configuration scanner, CVE properties 111 may correspond to a set of identified CVE properties determined by a static analysis scanner or a dynamic analysis scanner, malware properties may correspond to a set of malware properties determined by a malware analysis scanner or an antivirus scanner, and CWE properties 121 may correspond to a set of CWE properties determined by a static analysis scanner or dynamic analysis scanner. The above should not be taken to suggest that other scanner properties or logical groupings of properties determined by scanning applications cannot be stored in the container score database 102. For example, one or more scanner applications may determine different or additional configuration, CVE, malware, or CWE properties which may be logically grouped and stored in ways other than those illustrated and described herein.

In addition, a container score record 101 may contain context properties 126. Example context properties 126 may include version history 127, score history 128, environments 129, or other contextual information for a container image to which the container score record corresponds. For example, version history 127 may include one or more references to (e.g., an identifier of a container score record) or information from container score records of one or more past versions or updated versions of the container image, if available, to which the container score record corresponds. Score history 128 may include one or more historical scores determined for the container image to which the container score record corresponds. In some embodiments, the score history 128 comprises a past current container score 131 that has been updated in response to changes to one or more other properties 106, 111, 126, 121, 126. Environments 129 may include information about execution environments applicable to the container image. The information about execution environments 129 may comprise environment-specific values and other information for adjusting weights associated with one or more scanner properties 106, 111, 126, 121. Context properties 126 may also include other contextual properties described herein that are pertinent to determining a container score, such as the source or developer of a container image to which the container score record corresponds.

In some embodiments, the results engine 54 may access and store information in the container score 102 database. For example, the results engine 54 may request a container score record, e.g., 101A, from the container score database 102 to retrieve information in the container score record 101A; analyze, determine, or otherwise process one or more of the properties 106, 111, 126, 121, 126 associated with the container score record 101A; and store information about determined results (e.g., a container score 131) or otherwise update one or more of the properties (e.g., context properties 126) associated with the container score record 101A.

In some embodiments, the results engine 54 performs one or more operations in association with a scan of a distributed application or container image, which may be performed by a vulnerability scanning engine. As described previously, in some embodiments, a composition file repository may contain one or more composition files, each corresponding to a different multi-container application, and an image repository may store container images. Thus, score records, such as score records for distributed applications may be generated for and correspond to composition files in the repository and score records for container images may correspond to container images in the image repository. The results engine 54 may determine combined threat scores for the distributed applications or container images which are used by components such as the container manager 20 or by developers using, for example, a developer computer 58 to create new distributed application from existing container images or build upon existing container images. In turn, the combined threat scores may be considered during application or container development and deployment. For example, an IDE 60 of the developer computer 58 may include a plugin 62 to request one or more combined threat scores for container images or distributed applications.

As shown in FIG. 1B, the results engine 54 may include one or more components for evaluating properties associated with a container image, such as a configuration evaluator 105, CVE evaluator 110, malware evaluator 115, CWE evaluator 120, and a context evaluator 125. The results engine 54 may additionally include a container scorer 130 for determining a score, such as a combined threat score, for a container image based on the evaluations of the properties in a container score record. In some embodiments, a score evaluator 135A generates a report based on an evaluation of the combined threat score.

In some embodiments, such as where the results engine 54 is implemented within a vulnerability scanning engine, a controller of the vulnerability scanning engine may coordinate the operation of the results engine 54 and the components therein by directing them to perform their respective functions. In other embodiments, the results engine 54 may be implemented as a standalone functional block and include an API 140 to receive one or more requests (e.g., from a vulnerability scanning engine, developer computer 58, container manage 20, or other entity) to perform one or more functions and return the results of the performed functions to the requesting entity. In such cases, the results engine 54 may coordinate one or more operations independently of the vulnerability scanning engine, or even instruct the vulnerability scanning engine to perform one or more operations (e.g., an instruction to scan a container image to generate or populate information in a container score record within the container score database 102).

The configuration evaluator 105 may evaluate configuration properties 106 identified within a container score record associated with a container image. The configuration properties 106 may specify a configuration of the container or distributed application itself, such as whether it includes or uses, includes, or pertains to one or more services or application functions which may be more or less susceptible to different vulnerabilities it might include by virtue of its configuration. For example, if the configuration of the container specifies an API and does not utilize encryption, it may be more susceptible to certain types of attacks that have certain metrics. The different ones of the metrics may correspond to a category of metrics, such as exploitability metrics that may describe, in part, the thing that is vulnerable and the ease and technical means by which it can be exploited, or impact metrics that may describe, in part, the impacted component and the consequences of a successful exploit.

In some embodiments, the configuration evaluator 105 determines a weight for each metric or value of a metric based on whether the configuration properties implicate that the container is more, less, or neutrally susceptible to that metric or specific value associated with that metric. The configuration evaluator 105 may report weights based on configuration properties a weight vector, such as <Metric1, Value1, Weight1, Metric2, Value2, Weight2 . . . MetricN, ValueN, WeightN>. Other data formats may also be used. In some embodiments, the determined information is stored within the container score record to expedite future determinations by the results engine 54 or other components.

The CVE evaluator 110 may evaluate CVE properties 106 identified within a container score record associated with a container image. The CVE properties 106 may list known potential CVEs or other known vulnerabilities and exposures detected within the container image. Potential CVEs may be listed by an identifier of each CVE and may include obtained information about the CVE. Obtained information may be timestamped with a retrieval date. In some embodiments, if no additional information is included with a CVE identifier, or the timestamp for the additional information exceeds a threshold value, the CVE evaluator 110 may retrieve information about the CVE based on the identifier. For example, the CVE evaluator 110 may query a repository, database, or other entity with the CVE identifier to retrieve current information about the CVE. In turn, the CVE evaluator 110 may update the CVE properties 106 to associate the retrieved information with the CVE identifier. In some embodiments, a schema translator may perform one or more of the above operations or provide the obtained information in a unified schema.

In some embodiments, the CVE evaluator 110 may be configured to filter identified potential CVE vulnerabilities based on a list of known false positives, such as by interrogating a list of known false positives and filter out those that are documented as known false positives (which may include labeling those as being known false positives). In some embodiments, the CVE evaluator 110 may be configured to de-duplicate identified potential CVE vulnerabilities by collapsing multiples of a same identified CVE into a single CVE. The de-duplication in this case may include grouping the corresponding potential CVE vulnerabilities that identify the same underlying vulnerability into a group such that potential duplicates are not scored, or the de-duplication in this case may further include deleting all but one of the potential vulnerabilities in such a group.

In some embodiments, the CVE evaluator 110 may be configured to detect that a potential CVE vulnerability present in one layer is removed by a deletion or modification in a different higher layer and filter out those potential vulnerabilities that are addressed by the subsequent change. For example, a CVE vulnerability may be present in a first version of an application package in a container image and a higher layer may modify that lower layer to correspond to a subsequent version in which the potential vulnerability is removed.

The CVE evaluator 110 may be configured to evaluate the information associated with potential identified CVEs within the container image to determine one or more CVE weights. In some embodiments, the evaluation is performed subsequent to one or more filtering or de-duplication processes. In some embodiments, the obtained information associated with a CVE includes a base score, one or more component scores, or metrics such as a vector describing the CVE. In some embodiments, the vector may include metrics such as exploitability metrics and impact metrics having associated values. Exploitability metrics may describe, in part, the thing that is vulnerable and the ease and technical means by which it can be exploited, and the impact metrics may describe, in part, the impacted component and the consequences of a successful exploit. In some embodiments, the vector is populated with the information in a unified format, e.g., based on a mapping of CVE specific metrics and values to a unified vector format. For example, a CVSS (Common Vulnerability Scoring System) vector or other similar vector format may be mapped to a unified vector format. In some embodiments, a schema translator may perform one or more of the above operations or provide the obtained information in a unified schema. The CVE evaluator 110 may determine one or more CVE weights based on one or more of the scores for metrics of the vector.

Exploitability metrics may include one or more metrics and their values such as or similar to an attack vector indicating whether an attacker requires (N) network access (e.g., OSI layer 3), (A) adjacent network access (e.g., shared physical or local IP subnet), (L) local network access (e.g., read/write/execute capabilities), (P) physical access (e.g., via peripheral or other physical interaction), or other means; the complexity of the attack (e.g., (Low) whether success is likely under most circumstances or (High) only under specific circumstances); user privileges required, if any (e.g., (N) none, (Low) basic user, (High) administrative); user interaction required, if any (e.g., (N) none or (R) required); and so on. The exploitability metrics may contribute to one of the component scores.

Impact metrics may include one or more metrics and their values such as or similar to a confidentially impact (e.g., (N) no loss of restricted information, (L) some restricted information may be obtained, or (H) total loss of restricted information); integrity impact (e.g., (N) no modification of data, (L) some modification of data possible, (H) modification of any or all data is possible); availability impact (e.g., (N) no impact to performance or interruptions, (L) some impact to performance or interruptions possible, (H) total loss of performance or interruption possible); and so on. The impact metrics may contribute to one of the component scores.

In some embodiments, the CVE evaluator 110 determines a weight for each metric of an identified CVE based on at least one selected score. Depending on the embodiment, the selected score may be a component score to which the metric contributes, the base score, or both. Further, embodiments of the CVE evaluator 110 may normalize each selected score based on an upper and lower bound of the selected score to a given range (e.g., 0-1). In the case of the selection of multiple scores, the CVE evaluator 110 may calculate a weighted sum of the normalized score values or an average of the normalized score values. In turn, the CVE evaluator 110 assigns the calculated value as the weight for the metric.

The CVE evaluator 110 may report weights for a given CVE as a weight vector, such as <CVEID, Metric1, Value1, Weight1, Metric2, Value2, Weight2 . . . MetricN, ValueN, WeightN>. In some embodiments, the CVE evaluator 110 merges a plurality of weight vectors and reports weights for a set of CVEs (e.g., for one or more layers or a container image) as a single weight vector, such as <Metric1, Value1, Weight1, Metric1, Value2, Weight, Metric2, Value1, Weight3 . . . MetricN, ValueX, WeightY> where each of the weights in the single weight vector is a weighted sum or average of the weights of respective CVEs having a same Metric and Value. In either instance, the metrics of the identified potential CVEs, their respective values, and respective weights may be reported by the CVE evaluator 110. Other data formats may also be used. In some embodiments, the determined information is stored within the container score record to expedite future determinations by the results engine 54 or other components.

The malware evaluator 115 may evaluate malware properties 116 identified within a container score record associated with a container image. The malware properties 116 may list known potential malicious files, i.e., malicious or infected files, detected within the container image. Potential malicious files may be listed by an identifier of each file (e.g., file name/location) and may include information about the file. The information about the file may include image-specific information determined about the file such as a file name, file type, file location, file size, hash of the file, hash of a malicious portion of the file, one or more virus/malware signatures, whether the file or code is executed, etc. determined during a scan of the container image. The information may also include obtained information about the potential malicious file, such as a category (e.g., with a value malware or virus), type (e.g., with a value trojan, worm, monitoring tool/logger, backdoor, etc.), score (e.g., with a score value), aliases (e.g., with values corresponding to names of aliases), etc. The obtained information may be timestamped with a retrieval date. In some embodiments, if no obtained information is included with the identifier, or the timestamp for the obtained information exceeds a threshold value, the malware evaluator 115 may retrieve information about the potentially malicious file based on the determined information about the file. For example, the malware evaluator 115 may query a repository, database, or other entity with the file name, one or more hash values, and one or more signatures to obtain current information about the potentially malicious file. In turn, the malware evaluator 115 may update the malware properties 116 to associate the obtained information with the identifier of the potentially malicious file. In some embodiments, a schema translator may perform one or more of the above operations or provide the obtained information in a unified schema.

In some embodiments, the malware evaluator 115 may be configured to filter identified potential malicious file vulnerabilities based on a list of known false positives, such as by interrogating a list of known false positives and filter out those that are documented as known false positives (which may include labeling those as being known false positives). In some embodiments, the malware evaluator 115 may be configured to de-duplicate identified potential malicious file vulnerabilities by collapsing multiples of a same identified malicious file vulnerability (e.g., by aliases, hash, file name/location, etc.) into a single entry for the malicious file. The de-duplication in this case may include grouping the corresponding identifiers that identify the same malicious file vulnerability into a group such that potential duplicates are not scored, or the de-duplication in this case may further include deleting all but one of the potential vulnerabilities in such a group.

In some embodiments, the malware evaluator 115 may be configured to detect that a potential malicious file vulnerability present in one layer is removed by a deletion or modification in a different higher layer and filter out those potential vulnerabilities that are addressed by the subsequent change. For example, a malware file vulnerability may be present in a first version of an application package in a container image and a higher layer may modify that lower layer to correspond to a subsequent version in which the potential vulnerability is removed.

The malware evaluator 115 may be configured to evaluate the information associated with potential identified malicious files within the container image to determine one or more malware weights. In some embodiments, the evaluation is performed subsequent to one or more filtering or de-duplication processes. In some embodiments, the obtained information associated with a malicious file includes one or more scores (e.g., base scores from one or more reporting entities or component scores) and metrics with corresponding values such as a category (e.g., having a value malware or virus, etc.), type (e.g., having a value trojan, worm, monitoring tool/logger, backdoor, etc.), attack type (e.g., having a value denial of service, deletion or exposure of data, etc.) or other reported metrics about virus/malware files.

In some embodiments, one or more of these metrics may be represented in a vector describing a malicious file, for example, like that of a CVE. In some embodiments, the vector is constructed by populating it with obtained information in a unified format, e.g., based on a mapping of malware specific metrics and values to a unified vector format. For example, the metrics associated with a malicious file may be mapped to one or more other types of metrics describing similar information in the unified vector format. For example, if a malware file relates to a denial of service type attack, the mapping may specify corresponding metrics and values such as an attacker requires (N) network access (e.g., layer 3) and (N) no user privileges. Although the illustrated mapping suggests a mapping of metrics and values similar to the metrics and value in a CVE vector, the mapping to a unified format may comprise different metrics and values (e.g., to which one or both of malware metrics and values and CVE metrics and values are mapped). In some embodiments, a schema translator may perform one or more of the above operations or provide the obtained information in a unified schema.

In some embodiments, the obtained information includes one or more metrics and their respective values relative to a potentially malicious file. The different ones of the metrics may correspond to a category of metrics, such as exploitability metrics that may describe, in part, the thing that is vulnerable and the ease and technical means by which it can be exploited, or impact metrics that may describe, in part, the impacted component and the consequences of a successful exploit.

In some embodiments, the malware evaluator 115 determines a weight for each metric of an identified malicious file based on at least one selected score. Depending on the embodiment, the selected score may be a component score to which the metric contributes, a base score, or multiple. Further, embodiments of the malware evaluator 115 may normalize each selected score based on an upper and lower bound of the selected score to a given range (e.g., 0-1). In the case of the selection of multiple scores, the malware evaluator 115 may calculate a weighted sum of the normalized score values or an average of the normalized score values. In turn, the malware evaluator 115 assigns the calculated value as the weight for the metric.

The malware evaluator 115 may report weights for a given malware file as a weight vector, such as <FILEID, Metric1, Value1, Weight1, Metric2, Value2, Weight2 . . . MetricN, ValueN, WeightN>. In some embodiments, the malware evaluator 115 merges a plurality of weight vectors and reports weights for a set of malware files (e.g., for one or more layers or a container image) as a single weight vector, such as <Metric1, Value1, Weight1, Metric1, Value2, Weight, Metric2, Value1, Weight3 . . . MetricN, ValueX, WeightY> where each of the weights in the single weight vector is a weighted sum or average of the weights of respective malware files having a same Metric and Value. In either instance, the metrics of the identified potential malware files, their respective values, and respective weights may be reported by the malware evaluator 115. Other data formats may also be used. In some embodiments, the determined information is stored within the container score record to expedite future determinations by the results engine 54 or other components.

The CWE evaluator 120 may evaluate CWE properties 121 identified within a container score record associated with a container image. The CWE properties 121 may list known potential CWEs, i.e., software weaknesses types, detected within the container image. Potential CWEs may be listed by an identifier of each CWE and, optionally, include obtained information about the CWE. Obtained information may be timestamped with a retrieval date. In some embodiments, if no additional information is included with a CWE identifier, or the timestamp for the additional information exceeds a threshold value, the CWE evaluator 120 may retrieve information about the CWE based on the identifier. For example, the CWE evaluator 120 may query a repository, database, or other entity with the CWE identifier to retrieve current information about the CWE. In turn, the CWE evaluator 120 may update the CWE properties 121 to associate the retrieved information with the CWE identifier. In some embodiments, a schema translator may perform one or more of the above operations or provide the obtained information in a unified schema.

In some embodiments, the CWE evaluator 120 may be configured to filter identified potential CWE vulnerabilities based on a list of known false positives, such as by interrogating a list of known false positives and filter out those that are documented as known false positives (which may include labeling those as being known false positives). In some embodiments, the CWE evaluator 120 may be configured to de-duplicate identified potential CWE vulnerabilities by collapsing multiples of a same identified CWE into a single CWE. The de-duplication in this case may include grouping the corresponding potential CWE vulnerabilities that identify the same underlying vulnerability into a group such that potential duplicates are not scored, or the de-duplication in this case may further include deleting all but one of the potential vulnerabilities in such a group.

In some embodiments, the CWE evaluator 120 may be configured to detect that a potential CWE vulnerability present in one layer is removed by a deletion or modification in a different higher layer and filter out those potential vulnerabilities that are addressed by the subsequent change. For example, a CWE vulnerability may be present in a first version of an application package in a container image and a higher layer may modify that lower layer to correspond to a subsequent version in which the potential vulnerability is removed.

The CWE evaluator 120 may be configured to evaluate the information associated with potential identified CWEs within the container image to determine one or more CWE weights. In some embodiments, the evaluation is performed subsequent to one or more filtering or de-duplication processes. In some embodiments, the obtained information associated with a CWE includes a base score, one or more component scores, or metrics such as a vector describing the CWE. In some embodiments, the vector may include metrics such as base finding metrics, attack surface metrics, and environmental metrics. Although categorized differently, for ease of explanation, different ones of the base finding metrics, attack surface metrics, and environmental metrics describe exploitability metrics relating to the thing that is vulnerable and the ease and technical means by which it can be exploited or impact metrics relating to the impacted component and the consequences of a successful exploit. In some embodiments, the vector is populated with the information in a unified format, e.g., based on a mapping of CWE specific metrics and values to a unified vector format. For example, a CWSS (Common Weakness Scoring System) vector or other similar vector format may be mapped to a unified vector format. In some embodiments, a schema translator may perform one or more of the above operations or provide the obtained information in a unified schema. The CWE evaluator 120 may determine one or more CWE weights based on one or more of the scores for metrics of the vector.

In some embodiments, the CWE evaluator 120 determines a weight for each metric of an identified CWE based on at least one selected score. Depending on the embodiment, the selected score may be a component score (e.g., a base finding, attack surface, or environmental component score) to which the metric contributes, the base score, or both. Further, embodiments of the CWE evaluator 120 may normalize each selected score based on an upper and lower bound of the selected score to a given range (e.g., 0-1). In the case of the selection of multiple scores, the CWE evaluator 120 may calculate a weighted sum of the normalized score values or an average of the normalized score values. In turn, the CVE evaluator 110 assigns the calculated value as the weight for the metric.

The CWE evaluator 120 may report weights for a given CWE as a weight vector, such as <CWEID, Metric1, Value1, Weight1, Metric2, Value2, Weight2 . . . MetricN, ValueN, WeightN>. In some embodiments, the CWE evaluator 120 merges a plurality of weight vectors and reports weights for a set of CWEs (e.g., for one or more layers or a container image) as a single weight vector, such as <Metric1, Value1, Weight1, Metric1, Value2, Weight2, Metric2, Value1, Weight3 . . . MetricN, ValueX, WeightY> where each of the weights in the single weight vector is a weighted sum or average of the weights of respective CWEs having a same Metric and Value. In either instance, the metrics of the identified potential CWEs, their respective values, and respective weights may be reported by the CWE evaluator 120. Other data formats may also be used. In some embodiments, the determined information is stored within the container score record to expedite future determinations by the results engine 54 or other components.

The context evaluator 125 may evaluate context properties 126 identified within a container score record associated with a container image. The context properties 126 may include version history 127, score history 128, environments 129, or other contextual information for a container image to which the container score record corresponds. The context evaluator 125 may determine base weights or specific weights based on the context properties 126. For example, a base weight may be determined based on overall trends or factors expressed in the context properties 126. In addition, a specific weight may be selected for a metric or a specific metric and value based on more granular information expressed in the context properties 126. The weights determined by the context evaluator 125 may be applied to one or more of the weights determined by the scanner property evaluators e.g., 105, 110, 115, and 120 to modify them responsive to contextual information. In some embodiments, context properties 126 are stored in a taxonomy that specifies to which metric(s) or metric and value(s) (e.g., from a body of possible metrics or values reported by scanners) a given context property applies, or whether it should be applied globally. In turn, a weight may be determined based on the value of the context property and that the weight should be applied based on the taxonomy.

In some embodiments, the context evaluator 125 selects one or more metrics based on the context properties 126 and determines a weight for the metric, such as based on a value of the context property. The context evaluator 125 may additionally select a specific value of a metric based on the context properties 126 and determine a weight for the selected metric and associated value. Metrics and their values may be selected from a body of possible metrics and values that may be reported by the scanner property evaluators e.g., 105, 110, 115, and 120. In some embodiments, the metrics and their values are selected from a body of possible metrics and values of the unified vector format. In either instance, the metrics and values are selected by the context evaluator 125 such that corresponding metrics and value reported by the scanner property evaluators may be identified. In turn, a weight associated with corresponding metric and value reported by a given scanner property evaluator may be modified by the weight determined by the context evaluator. The weights determined by the context evaluator 125 may be bound to a given range (e.g., 0-1, 0-2, 0-10). In some embodiments the range of weights (e.g., 0-10) determined by the context evaluator 125 is greater than a range (e.g., 0-1) utilized by the scanner property evaluators, such that the weights based on context may significantly discount or amplify specific metrics.

In some embodiments, the context evaluator 125 may report weights for context as a weight vector, such as <Global Weight, Metric1, Value1, Weight1, Metric2, Value2, Weight2 . . . MetricN, ValueN, WeightN>. In some embodiments, a value for a given metric may be NULL, which may indicate that the weight applies to any reported value of the metric rather than a specific value. Other data formats may also be used. In this way, contextual information specified within the context properties 126 can be factored into specific vulnerability metrics that contribute to a container threat score.

For example, version history 127 may include one or more references to (e.g., an identifier of a container score record) or information from container score records of one or more past versions or updated versions of the container image, if available, to which the container score record corresponds. In turn, one or more weights may be determined based on revision changes indicating that specific vulnerabilities were addressed throughout the revisions. The version history 127 may also specify whether an updated version of a container is available that address one or more vulnerabilities, in which case, the weights associated with those vulnerabilities may be modified or a global weight modified to indicate that the container image is less secure.

Score history 128 may include one or more historical scores determined for the container image to which the container score record corresponds. In some embodiments, the score history 128 comprises a past current container score 131 that has been updated in response to changes to one or more other properties 106, 111, 126, 121, 126. Thus, for example, the score history 128 may indicate trends in the security of the container as new CVEs or CWEs or other exploits of the container are identified or their respective properties updated to either reflect an increase or decrease in vulnerability. In turn, one or more weights may be determined based on the trend in scores, which may be applied as a global weight, based on trends in scoring as further information is gained about vulnerabilities.

Environments 129 may include information about execution environments applicable to the container image. The information about execution environments 129 may include environment-specific values and other information for adjusting weights associated with one or more scanner properties 106, 111, 126, 121. Thus, for example, the execution environments 129 may indicate whether the container or distributed application is on an in-band network, out-of-band network, behind a firewall, behind an API, executed on a cloud service or within a company data center, and so on. Execution environment records may further indicate which portions of a container image are dormant and which are active in a given use case. For instance, a container image may include a subroutine that registered with a networks socket, but a composition file or other code may indicate that the subroutine is never invoked. Or an container image may include a library with module having a sys.exec command based on a passed value, but a call graph of a the larger distributed application may indicate that the sys.exec command module is never called. Environmental context may be hand-coded by a developer or inferred from the composition file or other configuration data of the distributed application. Vulnerabilities associated with dormant code may be down-weighted in some cases.

Depending on the information provided, metrics and values applicable to the execution environment may be selected and weights determined based on whether the execution environment increases or decreases the likelihood of metrics and values of a potential vulnerability. For example, if the execution environment of a container in behind a company firewall and for internal use, a weight may be specified for metrics and values implicating a vulnerability to a DDoS attack. And more specifically, the determined weight may discount those metrics and values as a threat.

Context properties 126 may also include other contextual properties described herein that are pertinent to determining a container score, such as the source or developer of a container image to which the container score record corresponds. Thus, for example, weights may be determined based on developer metrics, whether the container is official (e.g., Docker official container, modified docker official container, unknown), or other information about the source of the container.

The container scorer 130 may modify weights associated with different ones of properties reported by the scanner evaluators 105, 110, 115, 120 based on the weights associated with corresponding ones of the properties reported by the context evaluator 125. For example, a scanner property weight X for metric Y with value Z, may be modified based on a context property weight A applied to all weights, a context property weight B applied to weights associated with metric Y or a context property weight C applied to weights associated with metric Y with value Z. In a specific example, where the context evaluator 125 reports <Global Weight, Metric1, Value1, Weight1, Metric2, Value2, Weight2 . . . MetricN, ValueN, WeightN>, the container scorer may modify all weights reported by scanner evaluators, e.g., in a weight vector, by the global weight, modify reported Metric 1, Value1 weights by Weight 1, and so on, based on the context weight vector.

Once each of the context weights are applied, a combined threat score may be generated by the container scorer 130 based on the metrics and values and their associated modified weights. In some embodiments, the combined threat score is a numerical value. Thus, some embodiments may convert a non-numerical value associated with a given metric to a numerical value and apply the modified weight to the numerical value to generate a score for the metric. Thus, the score for a metric may be a weighted score based on one or more context properties. The scores, which can be weighted based on context properties, for the different metrics may be aggregated and reported as the combined threat score. In some embodiments, the combined threat score may be scaled to generate a score within a given range.

In some embodiments, the container scorer 130 is configured to calculate various aggregate metrics, such as the combine threat score, for a distributed application, container image, or subset thereof. In some cases, this may include calculating a combined threat score for a container image (in some cases, with a combined threat score specific to a layer or portions of a layer of the container image) and a combined threat score for a distributed application which may be based on scores of container images which constitute the distributed application. Combined threat scores may be based, for example, on a count of the number of potential vulnerabilities detected, a count of the number of potential vulnerability metrics having a score above a threshold, a count of the number of potential vulnerability metrics or different categories thereof having a score above a threshold, or other counts. Some embodiments may calculate a sum or weighted sum of the scores associated with the detected potential vulnerabilities or the potential vulnerability metrics or different categories thereof and some cases with different weights corresponding to different vulnerabilities or types of vulnerabilities in a taxonomy of vulnerabilities.

In some embodiments, the results engine 54 may include a score evaluator 135, such as score evaluator 135A. The score evaluator 135 may contextualize a combined threat score for a distributed application or container image among other distributed applications or container images. In some embodiments, the score evaluator 135 identifies one or more container score records 101 within a particular category, which may be identified based on a composition file for a distributed application or type of container, retrieves the container scores 131 associated with the different ones of the container files, and provides or displays the results. Additionally, the score evaluator 135 may provide an indication of whether a distributed application or container image is safe to use, such as by comparing a combined threat score to a threshold, where the threshold may be set based on administrator or company policy, or as a recommendation to developers.

As described previously, embodiments of the computing environment 10 or 100 may include infrastructure applications configured to deploy and manage the various distributed applications executing on computing devices. To this end, in some cases, the container manager 20 (such as an orchestrator) may be configured to deploy and configure containers by which the distributed applications are formed. In some embodiments, the container manager 20 may deploy and configure containers based on a description of the distributed application in a composition file in a composition file repository. In accordance with such embodiments, the container manager may include a score evaluator 135B to evaluate combined threat scores associated with distributed applications and the container images which constitute multi-container distributed applications. For example, the score evaluator 135B may evaluate one or more of the above described scores against a policy (e.g., a company or other policy set by an administrator) prior to orchestration. The score evaluator 135B may request one or more container scores 131 (or distributed application scores) from the container score database 102 based on a composition file or container image, such as by an identifier for the composition file or container image. In some embodiments, the identifier is a cryptographic hash and the return of the requested score records from the container score database 102 indicates that the distributed application or containers have been scanned or scored for vulnerabilities. Available scores may be evaluated. If a score is not available, the score evaluator 135B may transmit a request to the results engine 54 to determine one or more scores. In some embodiments, the scores are combined threat scores determined by the results engine 54. An example policy may indicate the applications and container images must be scanned and that their scores must meet a specific threshold or benchmark to be deployed in a given environment. The score evaluator 135B may reject distributed applications or containers that do not meet the policy. As described above, combined threat scores may be adjusted based on context properties for an execution environment. Hence, a given container may be determined safe to deploy in a given environment but not another, either due to a change in the score based on the context properties or different thresholds associated with the different environments in the policy.

In some embodiments, the results engine 54 may expose an API 140, like a RESTful API, by which the described functionality may be invoked. For example, the results engine 54 may receive a request for a combined threat score for a distributed application or a container image. In some embodiments, the results engine 54 may be configured to execute a process described below with reference to FIG. 5 to generate combined threat scores. In addition, in embodiments where the results engine 54 is a standalone component, other components and the results engine may interface with each other, such as via the API 140, to request and receive information. For example, the results engine 54 may request components (e.g., such as scanning engine 12) to execute a process described below with reference to FIG. 2 or 4 or the scanning engine may request the results engine to execute a process as described with reference to FIG. 5. The results engine 54 is described with reference to vulnerability scanning, such as security vulnerability scans, and generating a combined threat score based on vulnerability scan metrics, but the techniques described may be implemented in accordance with a variety of other types of testing, such as dynamic testing, functional testing, performance testing, and the like, with different types of testing applications invoked for different container images or portions thereof where contextual information may provide valuable information to a score based the testing in accordance with the techniques described below.

The present techniques, under the above-heading and elsewhere are, in many cases, described with reference to containers, but it should be emphasized that the present techniques are applicable to other forms of encapsulated functionality, including virtual machine images, machine images, unikernels, and AWS Lambda™ functions.

Process for Selectively Applying Heterogeneous Vulnerability Scans to Layers of Container Images

FIG. 2 shows an example of a process 200 by which the above-describe techniques may be implemented, in some cases by executing the process 200 with the scanning engine 12, though embodiments are not limited to that implementation, which is not to suggest that any other description herein is limiting. In some embodiments, the described functionality of FIG. 2 and elsewhere herein may be implemented with machine-readable instructions stored on a tangible, non-transitory, machine-readable medium, such that when the instructions are executed, the described functionality may be implemented. In some embodiments, notwithstanding use of the singular term “medium,” these instructions may be stored on a plurality of different memory devices (which may include dynamic and persistent storage), and different processors may execute different subsets of the instructions, an arrangement consistent with use of the singular term “medium.” In some embodiments, the described operations may be executed in a different order from that displayed, operations may be omitted, additional operations may be inserted, some operations may be executed concurrently, some operations may be executed serially, and some operations may be replicated, none of which is to suggest that any other description is limiting.

In some embodiments, the process 200 includes obtaining a container image, as indicated by block 202. Some embodiments may then determine whether there are more layers in the container image to process, as indicated by block 204, for instance, starting with a base layer or top layer. Upon determining that there are more layers in the container image to process, some embodiments may select a next layer, for instance, by identifying a layer that identifies the previously processed layer as a base layer or selecting a base layer, as indicated by block 206. Or some embodiments may process layers starting from a top layer downward by traversing a linked list of identifiers of parent layers. Some embodiments may then determine whether there are more scanner criteria to apply to the selected layer, as indicated by block 208. Upon determining that more scanner criteria remain to be applied, some embodiments may select a next scanner criteria, as indicated by block 210. Embodiments may then determine whether the selected criteria are satisfied by the selected layer, as indicated by block 212. In some embodiments, this may include calling a directory structure described at least in part by the selected layer and determining whether any file system objects satisfy the criteria. Upon determining that the criteria are satisfied (e.g., patterns are matched, or are not matched, depending on the criteria), some embodiments may designate the scanner corresponding to the selected criteria to scan the selected layer in a unified schema command, as indicated by block 214. Embodiments may then translate the unified schema command into a scanner-specific schema command, as indicated by block 216. Some embodiments may then command the selected scanner to scan, as indicated by block 218, or otherwise cause the selected scanner to perform the scan, for instance, by sending the translated scanner-specific command to the scanner. Some embodiments may then receive results in a scanner-specific schema, as indicated by block 220, and embodiments may then translate the scanner-specific schema results into the unified schema results, as indicated by block 222. In some cases, program flow may return to block 208, where embodiments may determine whether there are more scanner criteria to process. Upon determining there are, the next set of scanner criteria may be selected and program flow may return to block 212. Upon determining that the selected criteria are not satisfied by the selected layer, embodiments may return back to block 208. At block 208, upon determining that there are no more scanner criteria to process, program flow may return to block 214, and embodiments may determine whether there are more layers of the container image to process. Upon determining that there are no more layers, some embodiments may proceed to block 224, and filter potential vulnerabilities, for instance, removing duplicates and known false positives. Some embodiments may then calculate metrics on potential vulnerabilities, as indicated by block 226, and store the results, as indicated by block 228. Some embodiments may then cause the results to be presented, as indicated by block 230, for instance, in response to a request from a developer computing device for a webpage present in the results or in response to a developer operating a monolithic application implementing the scanning engine selecting input requesting results. In some embodiments, to expedite operations, one or more of the illustrated loops may be executed concurrently on different items, for instance, different layers may be processed concurrently by different processes, different scanner criteria may be processed concurrently by different processes, and different scans may be processed concurrently by different processes.

Independent Development Environment Configured to Annotate Source Code of Container Images with Notifications of Security Vulnerabilities

The following techniques may be uses in conjunction with the approaches above or independently, which is not to suggest that any other description is limiting.

In some cases, container images can be relatively complex, with more than five, and in many cases more than a dozen or two dozen constituent layers, and each of those layers can be subject to potential security vulnerabilities of varying types or varying risk. Developers often struggle with managing security vulnerabilities when faced with this complexity. The cognitive load of developing container images standing alone is relatively high, and layering on complexity from managing security vulnerabilities can potentially lead to missed vulnerabilities and less secure code. Further, even when developers are aware of such security vulnerabilities, accessing relevant information to assess the risk and potentially mitigate those risks is difficult and cumbersome, particularly when the developer needs to keep in mind both aspects of the container image and larger distributed application as well as aspects of the security vulnerabilities.

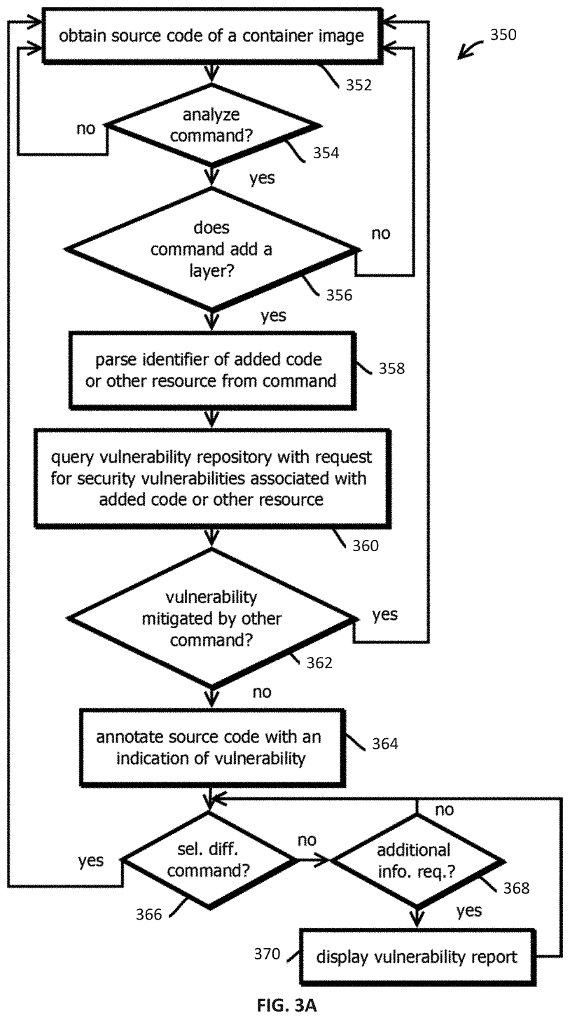

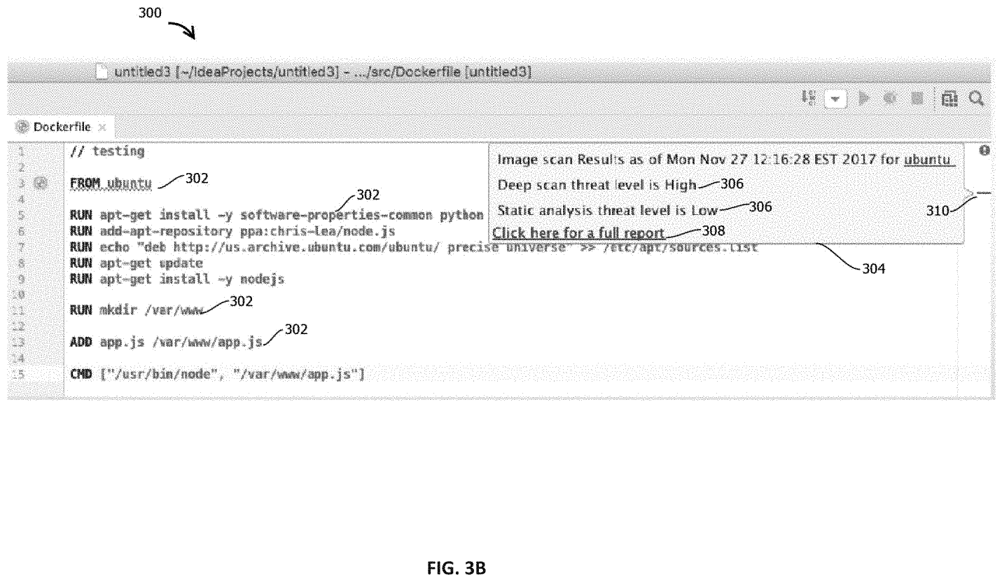

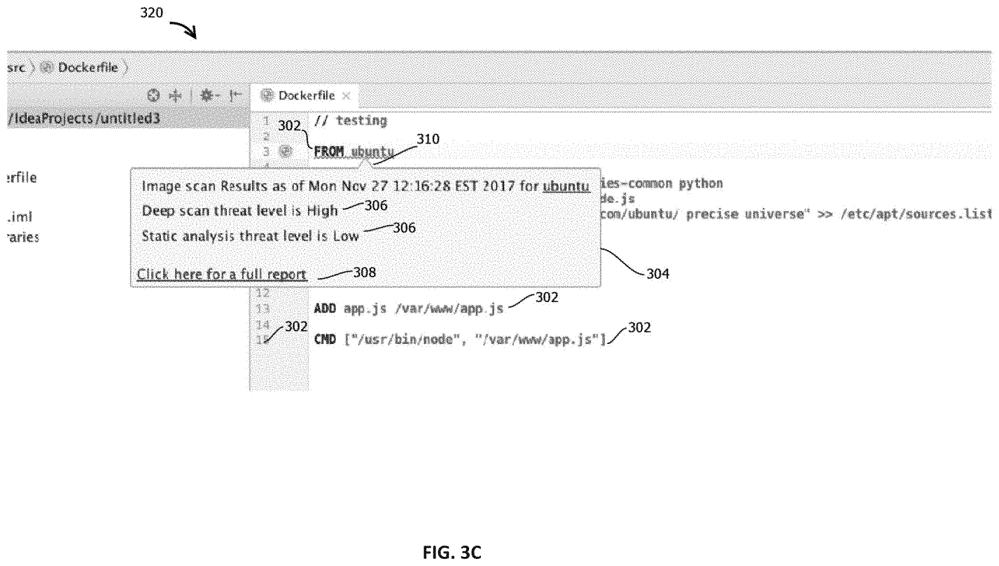

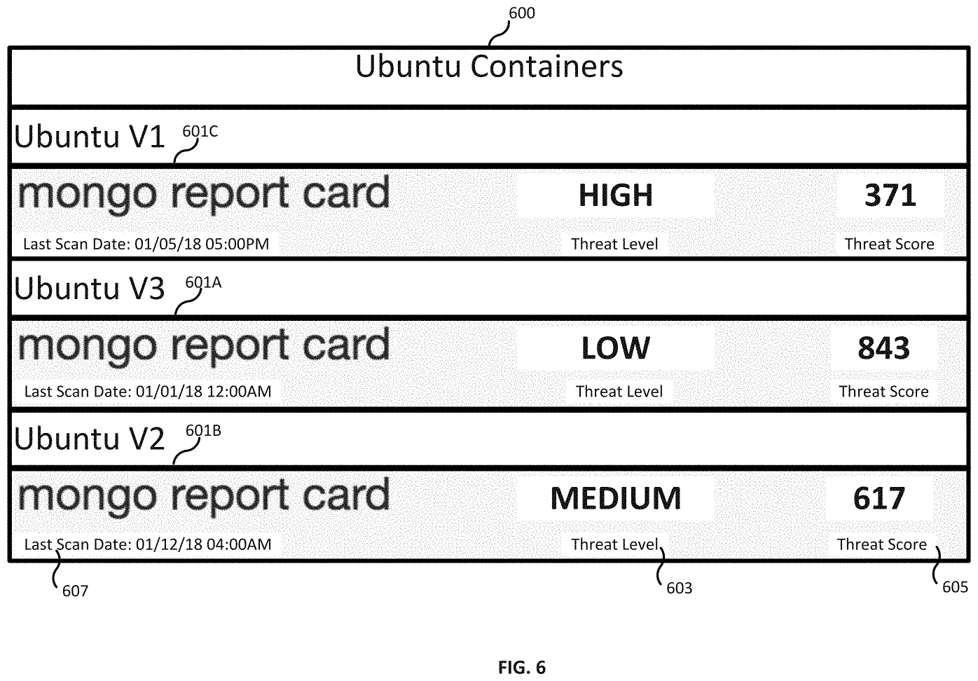

In some embodiments, the computing environment 10 of FIG. 1A or the computing environment 100 of 1B includes a developer computing device 58 with an independent development environment (IDE) 60 having a plug-in 62 that is expected to mitigate some of these challenges. It should be emphasized, though, that the techniques described below may be used independently of the techniques described above and vice versa, which is not to suggest that any other description herein is limiting. In some cases, potential security vulnerabilities may be surfaced with the techniques described above and brought to the developer's attention with the plug-in 62, or in some cases potential security vulnerabilities may retrieved from some other repository, such as a collection of security vulnerabilities for which reports are manually populated (like a CVE or CWE repository), which may include some public, network accessible repositories of security vulnerabilities 56. In some embodiments, the plug-in 62 may cooperate with the IDE 60 to execute a process described below with reference to FIG. 3A and provide user interfaces like those described below with reference to FIGS. 3B and 3C. In some embodiments, the plug-in 62 may request a combined threat score that may be generated as described below with reference to FIG. 5 and provide a user interface including information like that described below with reference to FIG. 6. A single developer computing device 58 is shown, but embodiments are expected to include substantially more in the computing environment 10 or 100, such as more than 10 or more than 100.

Some embodiments provide the ability to scan a Dockerfile for vulnerabilities that might be introduced by base images or additional files added to the container prior to the creation of the container. The scanning is done, in some embodiments, in the development IDE as the file is created and information about the vulnerabilities may be shown in real time (e.g., upon completion of a command).

In a typical devops environment, development teams are constantly updating/creating microservices in containers and deploying them to production multiple times a day. They need to have deep insight into vulnerabilities that will be introduced by them into the container that is going to be created and deployed with their services. During that development cycle, there is often no easy way for a developer or team of developers to determine if the images and files they are using, e.g., in a given base image, for a container are safe. They have often no insight into the vulnerabilities of the image and files prior to deployment from within the IDE.

Some embodiments allow the developer to reach out to a cloud service and compare the information found in the Dockerfile to information stored in a large repository for vulnerabilities. This approach leverages IDE abilities for issues specific to containers, images, and files, in some embodiments (though similar approaches are contemplated for virtual machines, orchestration configuration files, serverless configuration files, and the like). The information provided may be a conglomeration of scan results from different scan techniques (as opposed to just a single source of information) including but not limited to (which is not to suggest other lists are limiting) CVE and CWE information. The IDE plugin may also offer information on potential better usages that would be safer and provide less exposure, e.g., recommendations of mitigation strategies. The developer may be afforded real time data regarding the security risks that would be exposed by creating that container prior to building the container.

Consequently, some embodiments are expected to increase vulnerability awareness earlier in the workflow for container development, increase awareness of vulnerabilities in a more real time manner, increase collaboration between dev and sec ops teams, and provide a reliable mechanism that continuously updates and reports the latest information on vulnerabilities. To these ends and others, some embodiments may perform: injection into the IDE via plugin to allow monitoring of Dockerfiles; parsing Dockerfiles for key words that would indicate something is being create or added to the image (from, add, copy, etc. . . . ); performing a lookup on existing vulnerability information in CVE and CWE databases based to create annotations in the Dockerfile around potential exposures; and providing additional informational links in the annotations that allow the developer to get additional details on the exposure along with possible remediations. Thus, some embodiments leverage existing plugin architecture that does not require additional changes to the IDE or the development workflow using tooling in the existing installed infrastructure and are expected to provide a significantly higher level of safety during development due to fusion of vulnerability data into the IDE. It should be emphasized that embodiments are not limited to systems that afford every one of these benefits or address all of the problems discussed herein, as various independent useful approaches are described that may only address a subset of these issues, which is not to suggest that any other description is limiting.

In some embodiments, developer computing device 58 is a computing device upon which a developer of one of the above-described distributed applications composes or otherwise edits source code and other resources (like configuration files, images, styling instructions, and the like) of the distributed application. In some embodiments, such editing occurs within an IDE 60, such as the Visual Studio™ IDE or Eclipse™ IDE. In some cases, the IDE 60 may include a source code editor, like a text editor, build automation tools, a debugger, automatic code completion based upon partial code entry, a compiler, an interpreter, a version control system, a class browser, an object browser, a call graph browser, and the like. In some cases, as the developer enters or otherwise edits source code, some or all of these types of functionality may be automatically called to update outputs thereof, or in some cases some or all of these types of functionality may be called responsive to various events initiated by the user, such as entry of a white space character, entry of a newline character, or selection of an input requesting that the functionality be invoked.

In some embodiments, the IDE 60 may include an API by which it is extensible, for instance, with various plug-ins that the user may choose to install in the IDE 60. In some cases, upon installation, these plug-ins may register with the IDE 60 to receive various events implicating functionality of the plug-in and provide related context, and the plug-ins 62 may (in response to such events) access very aspects of program state of the IDE, in some cases including the source code being edited and related resources. In some cases, the illustrated plug-in 62 may instead be designed as an integrated part of the IDE 60 rather than a plug-in, which is not to suggest that any other description herein is limiting.

In some embodiments, the plug-in 62 may parse source code of a Dockerfile or other domain-specific programming language document by which a container image is specified (e.g., at least partially), and annotate commands (such as lines delimited by newline characters or other atomic units of invocation of functionality) with reports of potential security vulnerabilities to which the commands are subject (e.g., in virtue of vulnerabilities of resources added by the command). In some cases, subsets of commands may be distinctly annotated, for instance, with one portion of a command giving rise to one security vulnerability being separately annotated from another portion of a command giving rise to a different security vulnerability. In some cases, multiple security vulnerabilities to which a given command is potentially subject may be presented in a single annotation.

Commands may be checked responsive to various events. For example, a currently selected line may be checked (or otherwise scanned) responsive to each entry of a character, responsive to the user typing a white space character, responsive to entry of an end of line character, or responsive to the user selecting an input by which a verification is requested, or multiple lines may be checked responsive to one or more of these types of events.

In some embodiments, a given source code document may include a relatively large number of commands subject to relatively large number of potential security vulnerabilities. To avoid overloading the user, some embodiments may selectively display different subsets of the security vulnerabilities at different times based upon indications of which portions of the document have the user's attention. For example, some embodiments may annotate a currently selected line of source code on which a cursor of a text editor of the IDE is disposed and not annotate other lines of source code. Some embodiments may annotate lines of source code highlighted or otherwise selected by a user prior to requesting a report on whether those lines of source code are potentially subject to security vulnerabilities. Or some embodiments may annotate every line of source code currently viewable or every line of source code in a source code document concurrently.

Annotation may take various forms. The annotations of some embodiments visually indicate the line of source code to which the annotated material pertain. In some embodiments, the annotations are in the form of an overlaid region like those described below with reference to FIGS. 3B and 3C that overlays portions of the user interface of the IDE, in some cases including portions of the user interface displaying commands of the source code document. In some embodiments, the annotation may be positioned and sized such that the positioning and sizing indicates which line of source code is referenced by the annotation, for instance, positioning the annotation adjacent and below the line of source code to its annotation pertains, adjacent and above, or adjacent to the side. In some cases, the overlaid region may include an icon such as an arrow, triangular-shaped region, or the like that points towards the line of source code to which the overlay pertains.

Or in some cases, the annotation may be presented in a non-overlaid fashion, which is not to suggest that other descriptions herein are limiting. For example, in some cases the annotation may be presented in a window of a tiled window display of the IDE, for instance, in a different window from that of a text editor in which the source code is being edited. In some embodiments, the annotation may be presented in a gutter or a header or a sidebar of such a text editor. In some cases, the end annotation may be an audible signal, or in some cases, the annotation may be a visual indication, such as one including text describing one or more security vulnerabilities to which a line of source code is potentially vulnerable or otherwise subject.

In some embodiments, lines of source code or commands therein to which a security vulnerability or in annotation being displayed pertain may have a different visual weight in a user interface of the IDE from lines of source code or commands therein to which security vulnerabilities do not pertain or to which a currently displayed annotation does not pertain. A variety of different visual parameters may be adjusted to distinguish between such lines of source code or commands therein, including the following:
a. underlining at least part of a depiction of the first command in the user interface;
b. a font color of at least part of the depiction of the first command in the user interface;
c. a font size of at least part of the depiction of the first command in the user interface;
d. a font of at least part of the depiction of the first command in the user interface;
e. an italicization state of text at least part of the depiction of the first command in the user interface;
f. a bold state of text of at least part of the depiction of the first command in the user interface;
g. animation of at least part of the depiction of the first command in the user interface;
h. a background color of a line of text of at least part of the depiction of the first command in the user interface;
i. opacity of at least part of the depiction of the first command in the user interface;
j. an associated overlay region describing attributes of the first security vulnerability; or
k. an icon associated with at least part of the depiction of the first command in the user interface

In some embodiments, a single annotation may display information about a single security vulnerability (also referred to as a potential security vulnerability). Examples include when a scan was performed that revealed the security vulnerability, a type of scanning application that revealed the security vulnerability (or multiple instances thereof), an identifier of the body of code or other resource to which the security vulnerability pertains, and one or more classifications of the security vulnerability according to various criteria. In some cases, security vulnerabilities may be classified as high, medium, or low; scored on a scale of 1 to 10; assigned some other ordinal or cardinal classification based on attributes of vulnerabilities; labeled in a taxonomy or ontology of security vulnerabilities; or otherwise associated with classifications that make the security vulnerability faster for a developer to assess than if only provided its identifier.

In some cases, the annotation may include an indication of a type of harm associated with the security vulnerability, like indicating that the security vulnerability potentially allows for execution of remotely supplied code from an attacker, indicating that the security vulnerability potentially allows for the exfiltration of confidential information, indicating that the vulnerability leaks information about an encryption key, or indicating the security vulnerability potentially allows an attacker to direct network traffic elsewhere in a denial of service attack. In some embodiments, the annotation includes an indication of a mitigation strategy, such as an identifier of an alternate resource or body of code, like that of a later version or from a different provider that is not subject to the potential security vulnerability, for instance, with a link to that resource or text of an alternate command that the user can select to have substituted for the current command (and some embodiments may respond to receiving such a selection by effectuating the requested operation). Some embodiments may include wildcard characters in the representation of these alternate bodies of text, and those wildcard characters may be replaced with use case specific values in the current line of text, like a use-case specific path that is merged with the alternate body of text by replacing a corresponding wildcard character with the value from the current line of text. In some embodiments, the annotation may include links to bug reports and issue tracker entries addressing the security vulnerability.

In some embodiments, the annotation includes information pertaining to several security vulnerabilities, examples including classifications, rankings, scores, or other metrics based on attributes of the vulnerabilities, such as classifying the line of code as unsecure based upon a number of security vulnerabilities having risk scores above some value exceeding an aggregate threshold or based on presence of a particular type of vulnerability. In some embodiments, the annotation includes discrete entries for each of the security vulnerabilities, like a listing with any permutation of the above-described types of information relevant to security vulnerabilities. In some embodiments, the annotation pertains to a container image, for which a combined threat score pertaining to the container image may be displayed, like the example illustrated in FIG. 6. In some embodiments, an interface may list combined threat scores for one or more referenced container images. In some embodiments the plugin 62 may request one or more combined threat scores for referenced container images or request a scan for which a combined threat score may be generated, such as by the processes described with reference to FIGS. 4 and 5.

In some embodiments, to manage the user's cognitive load, presentation of information about security vulnerabilities may be staged, with a partial report like those shown in FIGS. 4 and 5 displayed with a link by which the user can access the full set of information for a vulnerability, which may include any permutation of the above-describe types of information about security vulnerabilities, including all of the above-describe types of information.

In some embodiments, the plug-in may execute a process 350 shown in FIG. 3A. In some cases, this may include obtaining source code of a container image, as indicated by block 352, which in some cases may be a Dockerfile or other body of source code serving the same or similar function. Obtaining the source code may be achieved by obtaining access to the source code, for instance, after registering a plug-in with a IDE that later holds the source code and program state and provides access to the plug-in. Accordingly, the source code can be said to have been obtained by a plug-in even if the entire body of source code is not held in program state of the plug-in itself—access is enough. In some cases, the source code may be obtained as a developer user edits the source code in a text editor of a IDE in which the plug-in is installed.

Some embodiments may determine whether to analyze commands of the source code, as indicated by block 354. As noted, this may be done responsive to various events, like entry of a character, entry of an end-of-line character, entry of a whitespace character, selection of lines in requests for analysis, saving of commands, requesting a build based upon commands, and the like. Some embodiments may determine whether to analyze a single command or a subset of commands, or all of the commands, in some cases based on the type of event, for instance, a single command in a single line may be analyzed responsive to user pressing the enter button. In some cases, the determination may include identifying a subset of commands in the source code to which the analysis will pertain. Upon determining not to analyze any commands, some embodiments may return to block 352, for instance, to obtain additional source code as a developer edits a source code document. Alternatively, upon determining to analyze a command, embodiments may proceed to the next operation.

Some embodiments may determine whether the command adds a layer to the container image, as indicated by block 356. In some embodiments, this operation may include analyzing syntax of the command with a lexer and a parser. Some embodiments may identify a sequence of tokens expressing the command. Some embodiments may determine whether the tokens include a reserved-term keyword signaling that a layer is to be added. Examples include, for the Dockerfile language “from,” “add,” “copy,” and the like. Some embodiments may transform the tokens into an abstract syntax tree, for instance, based on a grammar of the programming language and determine whether particular nodes of the tree corresponding to actions in which layers are added include or otherwise correspond to such keywords. Upon determining that a command adds a layer, some embodiments may proceed to the next operation, or upon determining that the command is not a layer, embodiments may return to block 352 and continue obtaining source code of the container image. It should be emphasized that obtaining source code of a container image can be performed without obtaining the full, final body of source code of that container image, for instance, a partially added source code file describing a container image can serve as the basis for performing the operation of block 352, even if the full container image is not yet fully coded.

Some embodiments may parse identifiers of added code or another resource from the command, as indicated by block 358. In some embodiments, the identifiers of a header of the resource may be obtained by traversing branches of a node of an abstract syntax tree identified in the previous operation as indicating a command to add a layer. In some embodiments, the identifier may be parsed from terms following (or otherwise positioned according to a language syntax or grammar) a keyword identified in the previous operation. In some embodiments, the identifier may be selected based on a grammar of the programming language and the text of the command, for instance by referencing rules in the grammar to determine which portions of the text of the command identify added code or other resources based on their position relative to the identified keyword. In some embodiments, the identifiers of added code or other resources may be identified based on flags, for instance, as a string of text following a flag before next flag is encountered, corresponding to the command. In some embodiments, a dictionary of flags pertaining to a command may be accessed, for instance by querying a man table of the command, and the code text of the command may be interrogated to identify tokens corresponding to those flags and text delimited by the flags, with text between flags in some cases serving as the identifier of added code or other resource.

Some embodiments may then query a vulnerability repository with a request for security vulnerabilities associated with the added code or other resource identified in the previous operation, as indicated by block 360. In some cases, this may include submitting the identifier in a query or performing a lookup to identify queries or other synonyms associated with the identifier to populate such a query. In some embodiments, identifying security vulnerabilities may include querying a manifest, inventory, or traversing a dependency or call graph of the added code or other resource correspond to the identifier and populating an inventory of other material invoked by the identifier. Some embodiments may then submit queries to the vulnerability repository with request for security vulnerabilities corresponding to these other materials and associate responsive potential security vulnerabilities with the command from which the identifier was parsed. In some embodiments, the vulnerability repository is a public vulnerability repository with previously documented vulnerabilities, in some cases stored in association with the identifier or corresponding term of the added code or other resource. In some cases, the vulnerability is revealed with the techniques described above with reference to FIG. 2. In some cases, the security vulnerability is previously documented, before the source code of the container images obtained or otherwise specified, or layers specified by Dockerfile commands may be scanned as they are entered. Some embodiments may receive query results with a list of vulnerabilities, in some cases with the values described above that are included in annotations. Or some embodiments may determine the values described above included in annotations based on individual reports of individual vulnerabilities, for instance, classifying vulnerabilities based on such report's results. In some embodiments, different users may have different policies for classifying vulnerabilities, and embodiments may apply rules in such a policy to classify vulnerabilities on a user-by-user (e.g., tenant-by-tenant in a SaaS offering) basis. In some cases, this policy may be stored in memory of the plug-in or accessed remotely.

Some embodiments may determine whether the identified vulnerabilities and query results are mitigated by other commands in the source code document, such as subsequent commands. For example, a vulnerability may be present in a base version of body of code added in a layer, and that vulnerability may be mitigated, for instance, eliminated, in a subsequent version of that body of code that is added to the container image in a subsequent layer corresponding to a subsequent command to apply an update to that body of code. Some embodiments may query a repository of change logs associated with identified version updates and match, for instance, unique security vulnerability identifiers indicated as being addressed in those change logs, to security vulnerabilities inquiry results to determine that the security vulnerability is fixed in the subsequent version. In some cases, the above-describe annotations for security vulnerability may include suggested text for a command to add such a fix, for instance, for automatic insertion in the source code document being edited in the IDE upon selection by the user from within the annotation. Upon determining that the vulnerability is mitigated, embodiments may return to block 352. Alternatively, upon determining that the vulnerability is not mitigated, embodiments may proceed to the next operation.

Some embodiments may annotate source code with an indication of vulnerability, as indicated by block 364. In some cases, the indication is a non-text indication, for instance, a change in background color of a line of the user interface in which the command subject to the vulnerability is displayed. In some cases, the indication is a change in font, font properties, or font state (like bolding, italicizing, underlining, striking through, and the like) of text of the command in a display of the user interface of the IDE. In some cases, the annotation is an overlay (e.g., UI element with a higher depth setting, such as a z-value than underlying elements), like those described above, or a display in an adjacent window or other window like those described above, including information such as text describing aspects of the security vulnerability or collection of security vulnerabilities pertaining to a corresponding command.

Some embodiments may analyze commands without displaying annotations or some types of annotations until a particular event is received. For example, some embodiments may analyze commands and apply non-text indications like those described above or changes in font, font properties, or font state, for each command analyzed and determined to have a security vulnerability, in response to determining that those commands have a security vulnerability, without displaying overlays or text reports about the security vulnerabilities until some subsequent event is received. For instance, vulnerable commands may be merely highlighted until selected, at which point an overlay may be displayed. Some embodiments may then determine that such an event has been received, for instance, an event identifying (e.g., a selecting a line) a given one of several commands subject to security vulnerability. Some embodiments may then, in response, cause an overlay or side window or other annotation to be displayed with information about the specified security vulnerability, without displaying similar annotations for other commands with security vulnerabilities that are not identified in the event.

Thus, in some embodiments, the user's cognitive load may be managed by presenting more granular information about security vulnerabilities pertaining to commands likely to currently have the user's attention, without overloading the user with information about every security vulnerability. Though embodiments are also consistent with concurrent displays of this more granular information for multiple commands or every command subject to a security vulnerability, which is not to suggest that any other description herein is limiting.

Some embodiments may determine whether the user has selected a different command, as indicated by block 366, and return to block 352 upon such a determination, in some cases continuing to display the annotation a block 364 or subsequent, more granular representations like an overlay box. Or in some cases, one or both of these types of annotations may be removed from the display responsive to the user selecting a different command.

In some embodiments, a given annotation may include an input by which the user requests additional information about one or more security vulnerabilities characterized in the annotation. Some embodiments may determine whether the user has selected this input to request additional information, as indicated by block 368. Examples include an input with a hyperlink to a more comprehensive report about the security vulnerability, or an input by which a user requests cached, even more granular, reports about the security vulnerability to be presented. In some cases, less and more granular reports may include any permutation of the above-described types of information about security vulnerabilities, with less information being presented in the less granular displays.

Upon determining that the user requests additional information, for instance, in response to receiving an event with an event handler indicating selection of the user input in the annotation, some embodiments may display the vulnerability report with the even more granular set of information, as indicated by block 370. In some cases, the event may include an identifier of the security vulnerability or collection of security vulnerabilities that are described by the annotation with the selected input, and the more detailed vulnerability report may be populated by retrieving records corresponding to that identifier. Alternatively, upon not receiving such a request, embodiments may return to block 366 to determine whether the user has selected a different command.

FIG. 3B depicts an example of a user interface 300 within an IDE in which a source code document having lines with commands 302 is being edited or otherwise inspected. As indicated, an overlay box 304 annotates line number three with information about security vulnerabilities to which the command of line number three is subject. As illustrated, the annotation in the overlay 304 may include classifications of the security vulnerability according to various criteria, as indicated by elements 306. The annotation further includes a user input 308 by which the user may request a more granular, and thus more detailed, report be displayed in the user interface 300 about the security vulnerability. The overlay further includes a visual feature 310 that specifies spatially in the user interface the line of the source code to which the overlay pertain, in this case aligning vertically with line number three.

FIG. 3C shows another example of a user interface 320 like that described above with a variation in the design of the overlay box 304. As illustrated, in this example, the overlay boxes positioned adjacent and below the line with the command 302 to which the overlay pertains. In some cases, such reports may be visually associated with lines with a variety of other techniques, for instance, by depicting an animated sequence in which the report is shown expanding and moving across the screen from a point on or adjacent the line to which the report pertains.

Processes for Determining a Combined Threat Score for a Distributed Application or Container Image

FIG. 4 shows an example of a process 400 by which the above-describe techniques may be implemented to determine one or more score records for a distributed application having one or more container images or a container image, in some cases by executing the process 400 with the scanning engine 12, though embodiments are not limited to that implementation, which is not to suggest that any other description herein is limiting. In some embodiments, the described functionality of FIG. 4 and elsewhere herein may be implemented with machine-readable instructions stored on a tangible, non-transitory, machine-readable medium, such that when the instructions are executed, the described functionality may be implemented. In some embodiments, notwithstanding use of the singular term “medium,” these instructions may be stored on a plurality of different memory devices (which may include dynamic and persistent storage), and different processors may execute different subsets of the instructions, an arrangement consistent with use of the singular term “medium.” In some embodiments, the described operations may be executed in a different order from that displayed, operations may be omitted, additional operations may be inserted, some operations may be executed concurrently, some operations may be executed serially, and some operations may be replicated, none of which is to suggest that any other description is limiting.

In some embodiments, the process 400 includes obtaining a container image, as indicated by block 402. In some embodiments the container image and/or information related to the container image may be identified by an identifier for the container image, which uniquely references the container image amongst other container images. For instance, embodiments may identify containers and/or container score records by an identifier such as a cryptographic hash of the container image (e.g., with a hash function such as SHA-256), and the cryptographic hash value serves as the identifier for the container image. In other embodiments, the identifier of the container image may be file name, location, version or combination of thereof that uniquely references the container image. Embodiments may determine 406 scanner properties for the obtained container image. Scanner properties may include properties determined by one or more scanners selected to scan the container image or portions thereof (e.g., one or more layers). For example, scanner properties may be determined as described with reference to FIG. 2. In some embodiments, scanner properties are determined as described with steps 204-222. That is, some embodiments may process layers starting from a top layer downward by traversing a linked list of identifiers of parent layers, scan the layers with one or more scanners, and translate the scanner-specific schema results into the unified schema results or scanner properties. The process may then create 408 a container score record for the container image. The container score record may include one or more of the identifiers determined for the container image, such that the container score record may be referenced, and include the scanner properties determined at block 406 for the container image.

In some embodiments, the process 400 includes additional steps for a distributed application. For example, the process 400 may begin with obtaining a distributed application 420. In some embodiments, a composition file of the distributed application is obtained, rather than the entirety of the application or components thereof. Some embodiments may then determine 421 an identifier for the distributed application, which uniquely references the distributed application amongst other distributed applications. For instance, embodiments may determine 421 an identifier such as a cryptographic hash of the composition file of the distributed application (e.g., with a hash function such as SHA-256), and the cryptographic hash value serves as the identifier for the distributed application. In other embodiments, the identifier of the distributed application may be file name, location, version or combination of thereof that uniquely references the distributed application. The process may then create 422 a distributed application score record for the distributed application. The distributed application score record may include one or more of the identifiers determined for the distributed application at block 421.

In some embodiments, a hierarchical representation (e.g., in the composition file) may specify a plurality of container images constituting the application which may perform one or more application functions or services associated with the distributed application. Alternatively, the distributed application may be analyzed to identify one or more container images. In either instance, container images associated with the distributed application (which may be a multi-container distributed application) may be identified at block 421 for processing. Upon determining at block 426 there exists a container image to process, steps 402-408 may be performed to process the container image, as described above. After the creation 408 of the container score record for the processed container image, the distributed application score record may be updated 428. For example, the distributed application score record may be updated with or otherwise associated with a record of scanner properties of the container image determined for the container image at blocks 406 and/or 408. In some embodiments, identifiers, such as a cryptographic hash identifier for the container images, are stored in association with the distributed application score record and may be used to reference the container score records created at block 408. The process 400 may return to decision block 426 to determine whether there exists a next container image to process iteratively according to steps 402-428. Upon determining there are no more container image to process at decision block 426, the process 400 may end 430.

In some embodiments, to expedite operations, one or more of the illustrated loops may be executed concurrently on different items, for instance, different containers of a distributed application may be processed concurrently by different processes.

FIG. 5 shows an example of a process 500 by which the above-describe techniques may be implemented to determine a combined threat score for a distributed application having one or more container images or a container image, in some cases by executing the process 500 with the results engine 54, though embodiments are not limited to that implementation, which is not to suggest that any other description herein is limiting. In some embodiments, the described functionality of FIG. 5 and elsewhere herein may be implemented with machine-readable instructions stored on a tangible, non-transitory, machine-readable medium, such that when the instructions are executed, the described functionality may be implemented. In some embodiments, notwithstanding use of the singular term “medium,” these instructions may be stored on a plurality of different memory devices (which may include dynamic and persistent storage), and different processors may execute different subsets of the instructions, an arrangement consistent with use of the singular term “medium.” In some embodiments, the described operations may be executed in a different order from that displayed, operations may be omitted, additional operations may be inserted, some operations may be executed concurrently, some operations may be executed serially, and some operations may be replicated, none of which is to suggest that any other description is limiting.

In some embodiments, the process 500 includes receiving a request for a combined threat score, such as a distributed application or a container image, as indicated by block 502. The request for a combined threat score may include an identifier of the distributed application or container image, such as a cryptographic hash or a file name. In some embodiments, the request may specify information relative to one or more context properties, such as an environment in which the distributed application or container will be used. The process 500 may query a database, such as a container score database 102, with the identifier, to retrieve an associated score record. The score record may be a score record for a distributed application or container image, such as a score record created by a process of FIG. 4. At decision block 504, if no score record is returned (e.g., none exists), a process 400 of FIG. 4 may be called to create a score record or files.

A returned score record may be examined for scanner property weights, as indicated by block 506. Upon determining that no scanner property weights exist or should be updated (e.g., a timestamp exceeds a threshold value), scanner property weights may be determined at block 508 and stored to the score record.

A returned score record may be examined for context property weights, as indicated by block 510. Upon determining that no context property weights exist or should be otherwise be updated, context properties may be determined at block 512. For example, if no context property weights exist for the specific environment information included in the request, the process may determine 515 one or more context properties, which may correspond to one or more scanner properties, based on the environmental information in the request. In some embodiments, if no context property weights exist, block 512 includes an additional step of requesting context property information, such as environment information, as a response to the request received at block 502. In turn, block 512 may receive a response including requested context property information and determine one or more context properties. Determined context properties may correspond to one or more scanner properties. For example, a determined context property may include a metric and a value from a body of metrics and their respective values represented in scanner properties. With context properties determined, weights are determined for the context properties at block 514.

Next, at block 516, weights associated with different ones of the scanner properties are modified based on weights of corresponding ones of the context properties. For example, a scanner property weight X for metric Y with value Z, may be modified based on a context property weight A applied to all weights, a context property weight B applied to weights associated with metric Y or a context property weight C applied to weights associated with metric Y with value Z. Thus, at block 516, one or more scanner properties matching a context property are identified and the weights associated with the identified scanner properties are modified based on the weight associated with the context property. Once each of the context property weights are applied, a combined threat score may be generated based on the modified scanner property weights as indicated by block 518. In some embodiments, the combined threat score is a numerical value. At block 518, some embodiments may convert a non-numerical value associated with a given metric to a numerical value and apply the modified weight to the numerical value to generate a score for the metric. The scores for the different metrics in the context properties may be aggregated and reported as the combined threat score. In some embodiments, the combined threat score may be scaled to generate a score within a given range. For example, if the aggregated score is a 5 (within a range of 1-10), it may be scaled by a factor of 10, or 100, or some other factor. Some embodiments may scale an aggregated score X by a factor or function (e.g., X<=5, X=350; X>=9, X=950; 5<=x<=9, X=f(x), where f is a scaling function for scores between 5 and 9) to generate a combined threat score on a scale that is familiar to users, like a credit score.

At block 520, the combined threat score may be reported 520. For example, the combined threat score may be returned in response to the request received at block 502. Embodiments may report combined threat score in a familiar format, such as a credit score. In some embodiments, the reported combined threat score is a report including additional information such as a last scan date and a threat level based on the combined threat score.

Example combined threat scores are illustrated in FIG. 6. FIG. 6 illustrates an example interface 600 displaying combined threat scores. The illustrated combined threat scores 605 for each of the containers or distributed applications (e.g., images of different Ubuntu versions V1, V2, V3) may be generated and reported by the process described in FIG. 5. For example, a developer may request combined threat scores associated with one or more Ubuntu containers in a repository, and the combined threat scores 605 for each of the requested Ubuntu containers are reported and displayed within an interface, such as a web interface in a browser or the interface of an IDE, on a developers computer 58. As shown in FIG. 6, a combined threat score may be reported and subsequently displayed with associated additional information in a familiar format. For example, as report cards, 601A, 601B, and 601C, for the respective Ubuntu images. The additional information may include a last scan date 607 (e.g., last date of a scan as described with reference to FIG. 2) and a threat level (e.g., low, medium, or high) based on the threat score.

In some embodiments, the process 500 includes additional steps (not shown) for a distributed application. For example, in some embodiments, a returned score record at block 504 may be for a distributed application which includes identifiers for one or more container images which constitute the distributed application. In turn, the process 500 may query the database, such as a container score database 102, with the identifiers to retrieve the respective score records for the container images. If a container score record is not received for a given identifier, a process 400 of FIG. 4 may be called to create a container score record. Steps 506-518 may be iterated through for each retrieved container score record. Additionally, one or more of steps 506-518 may be performed based on the score record for the distributed application. For example, in step 516, the process may further modify scanner property weights associated with one or more of the container images based on context property weights determined for the distributed application. In some embodiments, modified scanner property weights for the container images are merged prior to the further modification based on the context property weights determined for the distributed application. In turn, the combined threat score generated at block 518 in a similar fashion to that described above. In another example, at step 518, an aggregate combined threat score for the distributed application may be determined based on each of the combined threat scores associated with the container images. An aggregate threat score may be an average, a weighted sum, or other aggregate metric based on each of the combined threat scores associated with the container images which constitute the distributed application. At block 520, the combined threat score may be reported 520, such as described above with reference to FIG. 6.

In some embodiments, to expedite operations, one or more of the illustrated loops may be executed concurrently on different items, for instance, different score records of a distributed application may be processed concurrently by different processes.

FIG. 7 is a diagram that illustrates an exemplary computing system 1000 in accordance with embodiments of the present technique. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1050 may be configured to coordinate I/O traffic between processors 1010a-1010n, system memory 1020, network interface 1040, I/O devices 1060, or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct.

In this patent, certain U.S. patents, U.S. patent applications, or other materials (e.g., articles) have been incorporated by reference. The text of such U.S. patents, U.S. patent applications, and other materials is, however, only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

The present techniques will be better understood with reference to the following enumerated embodiments:

1. A method, comprising: obtaining, with one or more processors, a plurality of scanner properties pertaining to a container, the scanner properties being scanner outputs produced responsive to scanning the container, the scanner properties comprising: one or more CVE scanner properties determined for the container by a first scanner; and one or more CWE scanner properties determined for the container by a second scanner; determining, with one or more processors, weights for the plurality of scanner properties, each scanner property having an associated metric and value; obtaining, with one or more processors, context properties pertaining to an execution environment in which the container is deployable in a use-case; determining, with one or more processors, to which scanner properties each of the context properties applies within the execution environment and weights for the context properties; modifying, with one or more processors, by one or more of the weights determined for one or more respective context properties, the weights for the scanner properties to which the respective context properties apply to determine modified weights for at least some of the scanner properties; determining, with one or more processors, a combined threat score for the container in the use-case based on the at least some of the scanner properties having the modified weights and the other scanner properties; and storing, with one or more processors, the combined threat score in memory.
2. The method of embodiment 1, further comprising: receiving a request for a combined threat score, wherein the request specifies a hash identifier of the container determined by inputting code of the container into a hash function; and retrieving a score record for the container based on the hash identifier, the score record comprising the scanner properties, wherein: the combined threat score is a one-dimensional ordinal or cardinal value.
3. The method of embodiment 2, wherein retrieving the score record for the container based on the hash identifier comprises: receiving, in response to the request, an indication no score record exists for the hash identifier; and instructing a scanning engine to scan the container, wherein the scanning engine creates the score record for the container.
4. The method of any one of embodiments 1-3, further comprising: receiving a request for a combined threat score for a distributed application, wherein the request specifies a cryptographic hash identifier for the distributed application; retrieving a score record for the distributed application based on the cryptographic hash identifier, the score record implicating a plurality of containers including the container; and obtaining a plurality of score records corresponding to the plurality of containers, wherein one of the score records is for the container and includes the scanner properties pertaining to the container and the other score records are for the other containers and each includes scanner properties pertaining to respective ones of the other containers; and determining a combined threat score for the distributed application based on the scanner properties pertaining to the container and the other containers.
5. The method of any one of embodiments 1-4, wherein the score record for the distributed application implicates the plurality of containers by cryptographic hash identifier, the method further comprising: obtaining the plurality of score records corresponding to the plurality of containers based on the cryptographic hash identifier.
6. The method of any one of embodiments 1-5, further comprising: determining a combined threat score for a distributed application based on the scanner properties pertaining to the container and scanner properties pertaining to a plurality of other containers, wherein: determining the combines threat score for the distributed application comprises determining combined threat scores for the plurality of other containers; and determining the combined threat score for the distributed application based on the combined threat score for the container and the combined threat scores for the other containers.
7. The method of any one of embodiments 1-6, wherein obtaining context properties pertaining to an execution environment of the container comprises: receiving a request for the combined threat score; determining one or more context properties based on context information associated with the requests; and providing, in response to the request, the combined threat score accounting for the context information.
8. The method of any one of embodiments 1-7, wherein determining weights for the plurality of scanner properties comprises: computing a weight for a given scanner property based on one or more scores to which a metric of the given scanner property contributes.
9. The method of any one of embodiments 1-8, the scanner properties are determined by at least two scanners from the following: a static analysis scanner; a dynamic analysis scanner; a malware analysis scanner; an antivirus scanner; or a configuration scanner.
10. The method of any one of embodiments 1-9, comprising: receiving results from the plurality of different scanners in a plurality of different scanner-result schemas; and translating the results from the plurality of different scanners into a body of metrics and their values associated with one or more context properties.
11. The method of any one of embodiments 1-10, wherein a context property identifies one or more specific metrics represented in the scanner properties.
12. The method of any one of embodiments 1-11, wherein a context property identifies one or more specific metrics and one or more specific values of those metrics represented in the scanner properties.
13. The method of any one of embodiments 1-12, wherein a context property identifies a specific metric and a specific value of the metric represented in the scanner properties, the method further comprising: modifying the weight associated with the specific metric and the specific value by the weight associated with the context property; converting the specific value to a numerical value; and determining a score for the metric based on the numerical value and the modified weight.
14. The method of any one of embodiments 1-13, further comprising: comparing the combined threat score to a threshold specified in a policy for executing containers within the execution environment prior to execution of the container.
15. A tangible, non-transitory, machine-readable medium storing instructions that when executed by a data processing apparatus cause the data processing apparatus to perform operations comprising: the operations of any one of embodiments 1-14.
16. A system, comprising: one or more processors; and memory storing instructions that when executed by the processors cause the processors to effectuate operations comprising: the operations of any one of embodiments 1-14.

What is claimed is:

1. A method, comprising:
obtaining, with one or more processors, a plurality of scanner properties pertaining to a container, the scanner properties being scanner outputs produced responsive to scanning the container, the scanner properties comprising:
one or more Common Vulnerabilities and Exposures (CVE) scanner properties determined for the container by a first scanner; and
one or more Common Weakness Enumeration (CWE) scanner properties determined for the container by a second scanner;
determining, with one or more processors, weights for the plurality of scanner properties, each scanner property having an associated metric and value;
obtaining, with one or more processors, context properties pertaining to an execution environment in which the container is deployable in a use-case;
determining, with one or more processors, to which scanner properties each of the context properties applies within the execution environment and weights for the context properties;
modifying, with one or more processors, by one or more of the weights determined for one or more respective context properties, the weights for the scanner properties to which the respective context properties apply to determine modified weights for at least some of the scanner properties;
determining, with one or more processors, a combined threat score for the container in the use-case based on the at least some of the scanner properties having the modified weights and the other scanner properties; and
storing, with one or more processors, the combined threat score in memory.

2. The method of claim 1, further comprising:
receiving a request for a combined threat score, wherein the request specifies a hash identifier of the container determined by inputting code of the container into a hash function; and
retrieving a score record for the container based on the hash identifier, the score record comprising the scanner properties, wherein:
the combined threat score is a one-dimensional ordinal or cardinal value;
each of the weights corresponds to a different respective one of the scanner properties;
the context properties are indicative of which of a plurality of different subsets of functionality of the container are active in the use-case or which of the plurality of different subsets of functionality of the container are dormant in the use-case.

3. The method of claim 2, wherein retrieving the score record for the container based on the hash identifier comprises:
receiving, in response to the request, an indication no score record exists for the hash identifier; and
instructing a scanning engine to scan the container, wherein the scanning engine creates the score record for the container.

4. The method of claim 1, further comprising:
receiving a request for a combined threat score for a distributed application, wherein the request specifies a cryptographic hash identifier for the distributed application;
retrieving a score record for the distributed application based on the cryptographic hash identifier, the score record implicating a plurality of containers including the container; and
obtaining a plurality of score records corresponding to the plurality of containers, wherein one of the score records is for the container and includes the scanner properties pertaining to the container and the other score records are for the other containers and each includes scanner properties pertaining to respective ones of the other containers; and
determining a combined threat score for the distributed application based on the scanner properties pertaining to the container and the other containers.

5. The method of claim 1, wherein the score record for the distributed application implicates the plurality of containers by cryptographic hash identifier, the method further comprising:
obtaining the plurality of score records corresponding to the plurality of containers based on the cryptographic hash identifier.

6. The method of claim 1, further comprising:
determining a combined threat score for a distributed application based on the scanner properties pertaining to the container and scanner properties pertaining to a plurality of other containers, wherein:
determining the combines threat score for the distributed application comprises determining combined threat scores for the plurality of other containers; and
determining the combined threat score for the distributed application based on the combined threat score for the container and the combined threat scores for the other containers.

7. The method of claim 1, wherein obtaining context properties pertaining to an execution environment of the container comprises:
receiving a request for the combined threat score;
determining one or more context properties based on context information associated with the requests; and
providing, in response to the request, the combined threat score accounting for the context information.

8. The method of claim 1, wherein determining weights for the plurality of scanner properties comprises:
computing a weight for a given scanner property based on one or more scores to which a metric of the given scanner property contributes.

9. The method of claim 1, the scanner properties are determined by at least two scanners from the following:
a static analysis scanner;
a dynamic analysis scanner;
a malware analysis scanner;
an antivirus scanner; or
a configuration scanner.

10. The method of claim 1, comprising:
receiving results from the plurality of different scanners in a plurality of different scanner-result schemas; and
translating the results from the plurality of different scanners into a body of metrics and their values associated with one or more context properties.

11. The method of claim 1, wherein a context property identifies one or more specific metrics represented in the scanner properties.

12. The method of claim 1, wherein a context property identifies one or more specific metrics and one or more specific values of those metrics represented in the scanner properties.

13. The method of claim 1, wherein a context property identifies a specific metric and a specific value of the metric represented in the scanner properties, the method further comprising:
modifying the weight associated with the specific metric and the specific value by the weight associated with the context property;
converting the specific value to a numerical value; and
determining a score for the metric based on the numerical value and the modified weight.

14. The method of claim 1, further comprising:
comparing the combined threat score to a threshold specified in a policy for executing containers within the execution environment prior to execution of the container.

15. The method of claim 1, further comprising:
scanning the container with the first scanner, the second scanner, or both.

16. The method of claim 1, wherein:
determining the combined threat score comprises steps for determining a combined threat score.

17. A tangible, non-transitory, machine-readable medium storing instructions that when executed by one or more processors effectuate operations comprising:
obtaining, with one or more processors, a plurality of scanner properties pertaining to a container, the scanner properties being scanner outputs produced responsive to scanning the container, the scanner properties comprising:
one or more Common Vulnerabilities and Exposures (CVE) scanner properties determined for the container by a first scanner; and
one or more Common Weakness Enumeration (CWE) scanner properties determined for the container by a second scanner;
determining, with one or more processors, weights for the plurality of scanner properties, each scanner property having an associated metric and value;
obtaining, with one or more processors, context properties pertaining to an execution environment in which the container is deployable in a use-case;
determining, with one or more processors, to which scanner properties each of the context properties applies within the execution environment and weights for the context properties;
modifying, with one or more processors, by one or more of the weights determined for one or more respective context properties, the weights for the scanner properties to which the respective context properties apply to determine modified weights for at least some of the scanner properties;
determining, with one or more processors, a combined threat score for the container in the use-case based on the at least some of the scanner properties having the modified weights and the other scanner properties; and
storing, with one or more processors, the combined threat score in memory.

18. The medium of claim 17, the operations further comprising:
receiving a request for a combined threat score for a distributed application, wherein the request specifies a cryptographic hash identifier for the distributed application;
retrieving a score record for the distributed application based on the cryptographic hash identifier, the score record implicating a plurality of containers including the container; and
obtaining a plurality of score records corresponding to the plurality of containers, wherein one of the score records is for the container and includes the scanner properties pertaining to the container and the other score records are for the other containers and each includes scanner properties pertaining to respective ones of the other containers; and
determining a combined threat score for the distributed application based on the scanner properties pertaining to the container and the other containers.

19. The medium of claim 17, the operations further comprising:
determining a combined threat score for a distributed application based on the scanner properties pertaining to the container and scanner properties pertaining to a plurality of other containers, wherein:
determining the combines threat score for the distributed application comprises determining combined threat scores for the plurality of other containers; and
determining the combined threat score for the distributed application based on the combined threat score for the container and the combined threat scores for the other containers.

20. The medium of claim 17, wherein:
obtaining context properties pertaining to an execution environment of the container comprises:
receiving a request for the combined threat score;
determining one or more context properties based on context information associated with the requests; and
providing, in response to the request, the combined threat score accounting for the context information;
the operations further comprise:
receiving results from the plurality of different scanners in a plurality of different scanner-result schemas; and
translating the results from the plurality of different scanners into a body of metrics and their values associated with one or more context properties; and
a context property identifies a specific metric and a specific value of the metric represented in the scanner properties, the operations further comprising:
modifying the weight associated with the specific metric and the specific value by the weight associated with the context property;
converting the specific value to a numerical value; and
determining a score for the metric based on the numerical value and the modified weight.
